(19) United States
(12) Patent Application Publication
(10) Pub. No.: US 2010/0177388 A1
(43) Pub. Date: Jul. 15, 2010

(54) DIFFRACTIVE OPTICAL RELAY DEVICE WITH IMPROVED COLOR UNIFORMITY

(75) Inventors: Yoram Cohen, Tel-Aviv (IL); Amiram Eldar, Jerusalem (IL); Eyal Neistein, RaAnana (IL); Moti Itzkovitch, Petach-Tikva (IL); Yuval Aviel, Eshtaol (IL)

Correspondence Address: MARTIN D. MOYNIHAN d/b/a PRTSI, INC., P.O. BOX 16446, ARLINGTON, VA, 22215, US

(73) Assignee: Mirage Innovations Ltd., Petach-Tikva (IL)

(21) Appl. No.: 12/377,147

(22) PCT Filed: Aug. 22, 2007
(86) PCT No.: PCT/IL07/01048

§ 371 Date: Feb. 11, 2009

Related U.S. Application Data
(60) Provisional application No. 60/839,414, filed on Aug. 23, 2006.

(30) Foreign Application Priority Data
Sep. 7, 2006 (IL) PCT/IL06/01050
Sep. 7, 2006 (IL) PCT/IL06/01051

(51) Int. Cl. G02B 5/18

(52) U.S. Cl. 359/566

(57) ABSTRACT

An optical relay comprises a light-transmissive substrate having a plurality of diffractive optical elements, where at least one diffractive optical element is characterized by nonuniform diffraction efficiency. The substrate and diffractive optical elements are designed and constructed to relay at least a portion of a light beam emanating from an object to at least one predetermined eye-box in a manner such that for each point of the object, there is a set of parallel outgoing light rays originating from the point and arriving to the eye-box. The color difference between any two parallel light rays of the set is less than 50 ΔE* units.

### FIELD AND BACKGROUND OF THE INVENTION

The present invention relates to optics and, more particularly, to a diffractive optical relay device.

Miniaturization of electronic devices has always been a continuing objective in the field of electronics. Electronic devices are often equipped with some form of a display, which is visible to a user. As these devices reduce in size, there is an increase need for manufacturing compact displays, which are compatible with small size electronic devices. Besides having small dimensions, such displays should not sacrifice image quality, and be available at low cost. By definition the above characteristics are conflicting and many attempts have been made to provide some balanced solution.

An electronic display may provide a real image, the size of which is determined by the physical size of the display device, or a virtual image, the size of which may extend the dimensions of the display device.

A real image is defined as an image, projected on or displayed by a viewing surface positioned at the location of the image, and observed by an unaided human eye (to the extent that the viewer does not require corrective glasses). By contrast to a real image, a virtual image is defined as an image, which is not projected onto or emitted from a viewing surface, and no light ray connects the virtual image and an observer.

A virtual image can only be seen through an optic element, for example a typical virtual image can be obtained from an object placed in front of a converging lens, between the lens and its focal point. Light rays, which are reflected from an individual point on the object, diverge when passing through the lens, thus no two rays share two endpoints. An observer, viewing from the other side of the lens would perceive an image, which is located behind the object, hence enlarged. A virtual image of an object, positioned at the focal plane of a lens, is said to be projected to infinity. A virtual image display system, which includes a miniature display panel and a lens, can enable viewing of a small size, but high content display, from a distance much smaller than 25 cm. Such a display system can provide a viewing capability which is equivalent to a high content, large size real image display system, viewed from much larger distance.

Many conventional virtual image displays employ holographic optical elements. Holographic optical elements serve as an imaging lens and a combiner where a two-dimensional, quasi-monochromatic display is imaged to infinity and reflected into the eye of an observer.

U.S. Pat. No. 4,711,512 to Upatnieks, the contents of which are hereby incorporated by reference, describes a diffractive planar optics head-up display configured to transmit collimated light wavefronts of an image, as well as to allow light rays coming through the aircraft windscreen to pass and be viewed by the pilot. The light wavefronts enter an elongated optical element located within the aircraft cockpit through a first diffractive element, are diffracted into total internal reflection within the optical element, and are diffracted out of the optical element by means of a second diffractive element into the direction of the pilot's eye while retaining the collimation.

U.S. Pat. No. 5,966,223 to Friesem et al., the contents of which are hereby incorporated by reference describes a holographic optical device similar to that of Upatnieks, with the additional aspect that the first diffractive optical element acts further as the collimating element that collimates the waves emitted by each data point in a display source and corrects for field aberrations over the entire field-of-view. The field-of-view discussed is ±6°, and there is a further discussion of low chromatic sensitivity over wavelength shift of Δλ_{c} of ±2 nm around a center wavelength λ_{c} of 632.8 nM. However, the diffractive collimating element of Friesem et al. is known to narrow spectral response, and the low chromatic sensitivity at spectral range of ±2 nm becomes an unacceptable sensitivity at ±20 nm or ±70 nm.

U.S. Pat. No. 6,757,105 to Niv et al., the contents of which are hereby incorporated by reference, provides a diffractive optical element for optimizing a field-of-view for a multicolor spectrum. The optical element includes a light-transmissive substrate and a linear grating formed therein. Niv et al. teach how to select the pitch of the linear grating and the refraction index of the light-transmissive substrate so as to trap a light beam having a predetermined spectrum and characterized by a predetermined field of view to propagate within the light-transmissive substrate via total internal reflection. Niv et al. also disclose an optical device incorporating the aforementioned diffractive optical element for transmitting light in general and images in particular into the eye of the user.

A binocular device which employs several diffractive optical elements is disclosed in U.S. patent application Ser. No. 10/896,865 and in International Patent Application, Publication No. WO 2006/008734, the contents of which are hereby incorporated by reference. An optical relay is formed of a light transmissive substrate, an input diffractive optical element and two output diffractive optical elements. Collimated light is diffracted into the optical relay by the input diffractive optical element, propagates in the substrate via total internal reflection and coupled out of the optical relay by two output diffractive optical elements. The input and output diffractive optical elements preserve relative angles of the light rays to allow transmission of images with minimal or no distortions. The output elements are spaced apart such that light diffracted by one element is directed to one eye of the viewer and light diffracted by the other element is directed to the other eye of the viewer.

A common feature of many virtual image devices such as those disclosed by the above references, is the use of light transmissive substrate formed with diffraction gratings for coupling the image into the substrate and transmitting the image to the eyes of the user. The diffraction gratings, and particularly the diffraction gratings which are responsible for diffracting the light out of the substrate, are typically designed such that light rays impinge on the gratings more than one time. This is because the light propagates in the substrate via total internal reflection and once a light ray impinges on the grating, only a part of the ray's energy is diffracted while the other part continues to propagate and to re-impinge on the grating. Thus, light rays experience several partial diffractions where at each such partial diffraction a different portion of the optical energy exits the substrate. As a result, the optical output across the grating is not uniform.

Several approaches have been employed to improve the uniformity of optical output of diffractive elements.

U.S. Pat. No. 6,833,955 to Niv discloses an optical device having two light-transmissive substrates engaging two parallel planes. The substrates include diffractive optical elements to ensure that the light is expanded in a first dimension within one substrate, and in a second dimension within the other substrate. The efficiency of the diffractive elements varies locally for providing uniform light intensities.

Schechter et al., in an article entitled “Compact Beam Expander with Linear Gratings,” published on 2002 in Applied Optics, 41(7):1236-40, disclose the variation of the diffraction efficiency across an output grating in a beam expander by varying the modulation depth of the grating.

Eriksson et al., in an article entitled “Highly Directional Grating Outcouplers with Tailorable Radiation Characteristics,” published on 1996 in IEEE Journal of Quantum Electronics, 32(6):1038, discloses a grating outcoupler for outcoupling light out of a substrate by diffraction. The outcoupler enhances the directionality of the light such that the diffraction into the air is more dominant then the diffraction into the substrate. The spatial control of the emitted intensity in the grating plane is achieved by variations in the grating duty cycle and the radiation into the air is not uniform across the grating.

Weismann et al., in an article entitled “Apodized Surface-Corrugated Gratings With Varying Duty Cycles,” published on 2000 in IEEE Photonics Technology Letters, 12(6):639, teach optical output in which side lobes of a Bragg grating outside a certain bandwidth around the Bragg resonance wavelength are suppressed by concatenating different duty cycles.

Additional references of interest include, U.S. Pat. Nos. 5,742,433, 6,369,948, 6,927,915, 4,886,341, 5,367,588, 5,574,597 and 6,008,941, U.S. Published Application Nos. 20040021945, 20030123159 and 20060051024, International Patent Application Publication Nos. WO 2004/109349 and WO 99/52002, and Japanese Patent No. 90333709;

### SUMMARY OF THE INVENTION

The present inventors have discovered a technique for providing a light beam having low color aberrations. It was uncovered by the present inventors, that when a light beam is transmitted by an optical device, it is sufficient to ensure low color aberrations over a part of the beam's cross section. The present inventors have demonstrated that this can considerably improve the performances of devices and systems employing diffractive optics.

In various exemplary embodiments of the invention, an incoming light beam having a plurality of incoming light rays is diffracted so as to provide an outgoing light beam having a plurality of outgoing light rays. In some embodiments of the present invention, the shape of the color profile of the light beam is substantially preserved across a predetermined angular divergence relative to the axis of the outgoing light beam.

In various exemplary embodiments of the invention, a light relay device is configured to receive an incoming light beam emanating from an object and relay at least a part of the light beam to one or more predetermined two-dimensional regions. Thus, an image of the object is transmitted to the predetermined two-dimensional region(s). The image is preferably transmitted such that for each point of the object, there is a set of parallel outgoing light rays originating from the point and arriving to to the predetermined two-dimensional region, where the color difference between any two outgoing light rays of the set is substantially small.

In various exemplary embodiments of the invention an incoming light beam is diffracted to provide an outgoing light beam propagating in the air. The outgoing light beam can emanate from an object. Over at least part of the outgoing light beam, the color difference between colors of any two outgoing light rays respectively originating from two incoming light rays having the same color is substantially small. When the incoming beam emanate from an object, the part of the light beam constitutes an image of the object, where any two image points having substantially the same color correspond to object points having the same color.

In some embodiments of the present invention, the part of the outgoing light beam is characterized by a field-of-view of at least 10°. Optionally and preferably, the part of the outgoing light beam is a plurality of outgoing light rays propagating in the air into the predetermined two-dimensional region.

When embodiments of the present invention are used for human vision, the two-dimensional regions can serve as eye-boxes where the user can place the eyes, e.g., to view the image. In various exemplary embodiments of the invention, the optical imagery information of the part of the light beam which arrives to the eye-box is substantially the same as the optical imagery information of the incoming light beam, apart from an overall power difference due to optical losses. Thus, the image of the object is transmitted with low color aberrations.

In some embodiments of the present invention, two or more relay devices are used for transmitting a light beam. This is particularly useful when it is desired to transmit chromatic light beam. In such embodiments, different sub-spectra can be relayed by different devices. This can reduce optical losses, because each relay device can be optimized according to the sub-spectrum relayed thereby.

Typically, the light relay device of the present embodiments comprises a light transmissive substrate having a plurality of diffractive optical elements serving as input and output elements. Low color aberrations across the eye-box(s) can be achieved by judicious selection of the diffraction parameters of the optical elements for a given geometrical configuration. In various exemplary embodiments of the invention the output diffractive optical element(s) of the relay device has a pre-designed nonuniform diffraction efficiency selected to achieve the desired uniformity.

According to one aspect of the present invention there is provided an optical relay device. The optical relay device comprises a light-transmissive substrate having a plurality of diffractive optical elements, where at least one diffractive optical element is characterized by nonuniform diffraction efficiency.

According to further features in preferred embodiments of the invention described below, the substrate and the diffractive optical elements are designed and constructed to relay at least a portion of a light beam emanating from an object to at least one predetermined eye-box in a manner such that for each point of the object, there is a set of parallel outgoing light rays originating from the point and arriving to the eye-box.

According to another aspect of the present invention there is provided a method suitable for transmitting an image of an object. The method comprises diffracting at least a portion of a light beam emanating from the object to provide an outgoing light beam propagating in the air, such that for each point of the object, there is a set of parallel outgoing light rays originating from the point and arriving to at least one predetermined eye-box.

According to still further features in the described preferred embodiments a color difference between any two parallel light rays of the set is less than 50 ΔE* units.

According to still further features in the described preferred embodiments the color difference between colors of any two outgoing light rays which originate from points of the object having the same color and which arrive to the eye-box is less than 50 ΔE* units.

The above embodiments can be ensured by a judicious design and construction of at least one of the substrate and the diffraction optical elements of the device.

According to some embodiments of the present invention the substrate and the diffractive optical elements are designed and constructed such that when an incoming white light beam impinges the device, an outgoing light beam characterized by a maximal color deviation of less than 50 ΔE* units across a field-of-view of at least 10 degrees exits the device into at least one predetermined eye-box.

In some embodiment of the present invention the color difference or color deviation is less than 40 ΔE* units, more preferably less than 30 ΔE* units, even more preferably less than 20 ΔE* units.

According to another aspect of the present invention there is provided apparatus for transmitting a light beam having a spectrum of wavelengths. The apparatus comprises a plurality of optical relay devices (e.g., two or three optical relay devices). In various exemplary embodiments of the invention at least one, more preferably at least two of the optical relay devices is the optical relay device described herein.

According to further features in preferred embodiments of the invention described below, each optical relay device of the plurality of optical relay devices is designed and constructed to relay, substantially exclusively, a different spectral portion of the light beam, wherein each spectral portion corresponds to a sub-spectrum of the spectrum. According to still further features in the described preferred embodiments each optical relay device is a planar optical device engaging a different plane.

According to an additional aspect of the present invention there is provided a method suitable for transmitting a light beam. The method comprises operating the optical relay device or apparatus described herein, thereby transmitting the light beam.

According to still further features in the described preferred embodiments the diffractive output optical elements are designed and constructed to diffract a respective spectral portion of the light beam out of the substrate, while allowing other spectral portions of the light beam to pass through the at least one output diffractive optical element with minimal or no diffraction.

According to still another aspect of the present invention there is provided a system for providing an image to a user. The system comprises an optical relay device such as the optical relay device described herein, and an image generating system for providing the optical relay device with collimated light constituting the image. According to further features in preferred embodiments of the invention described below, the system comprises the apparatus described herein.

According to further features in preferred embodiments of the invention described below, the plurality of diffractive optical elements comprises at least one output diffractive optical element respectively corresponding to the at least one predetermined eye-box, wherein a length of each predetermined eye-box is less than 80% of a length of a respective output diffractive optical element. In some embodiments of the present invention the length of each predetermined eye-box is less than 50% of a length of a respective output diffractive optical element.

According to further features in preferred embodiments of the invention described below, the diffractive optical elements comprise an input diffractive optical element, a left output diffractive optical element and a right output diffractive optical element being laterally displaced from the left output diffractive optical element.

According to still further features in the described preferred embodiments at least one output diffractive optical element is a linear grating.

According to still further features in the described preferred embodiments the nonuniform diffraction efficiency is effected by a nonuniform duty cycle of the linear grating.

According to still further features in the described preferred embodiments the nonuniform diffraction efficiency is effected by a nonuniform modulation depth.

According to still further features in the described preferred embodiments at least one of the diffractive optical elements is a reflective optical element. According to still further features in the described preferred embodiments the reflective optical element comprises a reflective coat.

According to still further features in the described preferred embodiments at least one of the diffractive optical elements comprises a plurality of segments, wherein at least two of the segments are characterized by different diffraction efficiencies.

According to still further features in the described preferred embodiments at least one of the plurality of diffractive optical elements comprises a linear diffraction grating having a substantially uniform modulation depth of about 216 nm and a nonuniform duty cycle being effected by eight concatenated segments of the grating, wherein respective duty cycles characterizing the eight concatenated segments are: about 15%, about 15%, about 13%, about 15%, about 15%, about 16%, about 23% and about 14%.

According to still further features in the described preferred embodiments at least one of the diffractive optical elements comprises a linear diffraction grating having a substantially uniform modulation depth of about 180 nm and a nonuniform duty cycle being effected by eight concatenated segments of the grating, wherein respective duty cycles characterizing the eight concatenated segments are: about 19%, about 19%, about 22%, about 14%, about 13%, about 12%, about 12% and about 23%.

According to a further aspect of the present invention there is provided a method suitable for designing an optical apparatus having at least one light-transmissive substrate and a plurality of diffraction gratings in a predetermined arrangement over the at least one light-transmissive substrate. The method comprises: selecting grating parameters for the diffraction gratings; under constraints induced by the arrangement and the grating parameters, simulating white ray tracing, within the apparatus and into at least one predetermined eye-box being at a predetermined distance from the at least one substrate, for a plurality of different rays and a plurality of different wavelengths; based on the ray tracing, calculating a color profile across the at least one predetermined eye-box; and repeating the selection, the simulation and the calculation until the color profile is characterized by a maximal color deviation of less than 50 ΔE* units, more preferably less than 40 ΔE* units, more preferably less than 30 ΔE* units, more preferably less than 20 ΔE* units.

According to further features in preferred embodiments of the invention described below, the selection of grating parameters comprises defining a plurality of segments for at least one grating of the plurality of gratings, and selecting a diffraction efficiency for each segment of the plurality of segments.

According to still further features in the described preferred embodiments the grating has a uniform period.

According to still further features in the described preferred embodiments the selection of diffraction efficiency comprises selecting a duty cycle.

According to still further features in the described preferred embodiments the selection of diffraction efficiency comprises selecting a modulation depth.

According to still further features in the described preferred embodiments the grating has at least eight segments.

According to still further features in the described preferred embodiments the length of at least one segment is shorter than a minimal hop-length characterizing ray propagation within the at least one light transmissive substrate.

According to still further features in the described preferred embodiments the length of at least one segment is shorter than 3 millimeters.

According to still further features in the described preferred embodiments the length of at least one segment equals the period of the grating.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of diffraction of light by a linear diffraction grating operating in transmission mode;

FIGS. 2a-d are schematic illustrations of cross sectional views of an optical relay device, according to various exemplary embodiments of the present invention;

FIG. 3 is a schematic illustration of ray propagation in a relay device, according to various exemplary embodiments of the present invention;

FIG. 4 is a schematic illustration of a top view of a diffractive optical element, according to various exemplary embodiments of the present invention;

FIG. 5a is a schematic illustration of a grating having a non-uniform duty cycle, according to various exemplary embodiments of the present invention;

FIG. 5b is a schematic illustration of a grating having a non-uniform modulation depth, according to various exemplary embodiments of the present invention;

FIG. 5c is a schematic illustration of a grating having a non-uniform duty cycle and a non-uniform modulation depth, according to various exemplary embodiments of the present invention;

FIGS. 6a-c are schematic illustrations of field-of-view angles of an optical relay device, according to various exemplary embodiments of the invention;

FIGS. 7a-b are schematic illustrations of a perspective view (FIG. 7a) and a side view (FIG. 7b) of a relay device, in an embodiment of the invention in which one input optical element and two output optical elements are employed;

FIGS. 8a-b are schematic illustrations of wavefront propagation within a light transmissive substrate, in embodiments of the invention in which diffractive elements are employed;

FIGS. 9a-b are schematic illustration of an optical apparatus, according to various exemplary embodiments of the present invention;

FIG. 10 is a schematic illustration of an optical apparatus in an embodiment in which each optical relay device of the apparatus comprises two output elements, according to various exemplary embodiments of the present invention;

FIG. 11 is a schematic illustration of an optical apparatus, according to various exemplary embodiments of the present invention;

FIG. 12 is a schematic illustration describing ray tracing simulations performed according to which various exemplary embodiments of the present invention; and

FIG. 13 shows spectra of RGB primaries of an input white light used in simulations performed according to some embodiments of the present invention;

FIGS. 14-16 are graphs showing the simulation results for three types of optical apparatus.

### DESCRIPTION OF EXEMPLARY EMBODIMENTS

The present embodiments comprise a device, apparatus, system and method which can be used for transmitting light. Specifically, the present embodiments can be used to transmit a light beam such as to reduce color aberrations over at least part of the beam's divergence.

The principles and operation of a device, apparatus, system and method according to the present embodiments may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

When a ray of light moving within a light-transmissive substrate and striking one of its internal surfaces at an angle φ₁ as measured from a normal to the surface, it can be either reflected from the surface or refracted out of the surface into the open air in contact with the substrate. The condition according to which the light is reflected or refracted is determined by Snell's law, which is mathematically realized through the following equation:

n_{A} sin φ₂=n_{S} sin φ₁, (EQ. 1)

where n_{S} is the index of refraction of the light-transmissive substrate, n_{A} is the index of refraction of the medium outside the light transmissive substrate (n_{S}>n_{A}), and φ₂ is the angle in which the ray is refracted out, in case of refraction. Similarly to φ₁, φ₂ is measured from a normal to the surface. A typical medium outside the light transmissive substrate is air having an index of refraction of about unity.

As used herein, the term “about” refers to ±10%.

As a general rule, the index of refraction of any substrate depends on the specific wavelength λ of the light which strikes its surface. Given the impact angle, φ₁, and the refraction indices, n_{S} and n_{A}, Equation 1 has a solution for φ₂ only for φ₁ which is smaller than arcsine of n_{A}/n_{S} often called the critical angle and denoted α_{c}. Hence, for sufficiently large φ₁ (above the critical angle), no refraction angle φ₂ satisfies Equation 1 and light energy is trapped within the light-transmissive substrate. In other words, the light is reflected from the internal surface as if it had stroked a mirror. Under these conditions, total internal reflection is said to take place. Since different wavelengths of light (i.e., light of different colors) correspond to different indices of refraction, the condition for total internal reflection depends not only on the angle at which the light strikes the substrate, but also on the wavelength of the light. In other words, an angle which satisfies the total internal reflection condition for one wavelength may not satisfy this condition for a different wavelength.

When a sufficiently small object or sufficiently small opening in an object is placed in the optical path of light, the light experiences a phenomenon called diffraction in which light rays change direction as they pass around the edge of the object or at the opening thereof. The amount of direction change depends on the ratio between the wavelength of the light and the size of the object/opening. In planar optics there is a variety of optical elements which are designed to provide an appropriate condition for diffraction. Such optical elements are typically manufactured as diffraction gratings which are located on a surface of a light-transmissive substrate. Diffraction gratings can operate in transmission mode, in which case the light experiences diffraction by passing through the gratings, or in reflection mode in which case the light experiences diffraction while being reflected off the gratings

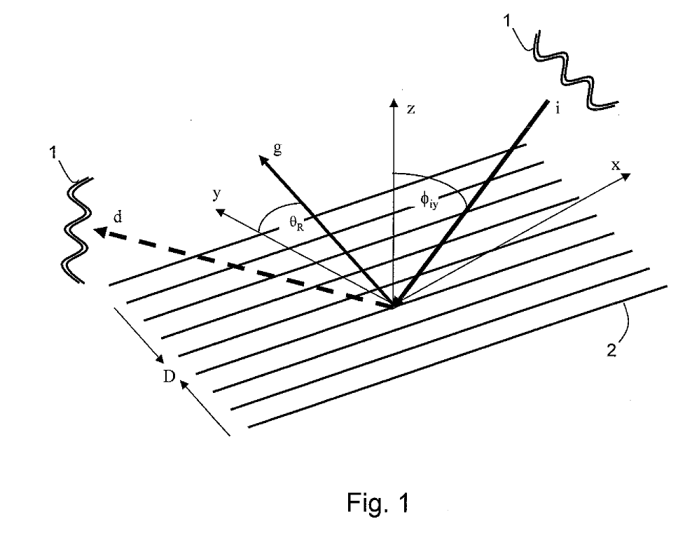

FIG. 1 schematically illustrates diffraction of light by a linear diffraction grating operating in transmission mode. One of ordinary skills in the art, provided with the details described herein would know how to adjust the description for the case of reflection mode.

A wavefront 1 of the light propagates along a vector i and impinges upon a grating 2 engaging the x-y plane. The normal to the grating is therefore along the z direction and the angle of incidence of the light φᵢ is conveniently measured between the vector i and the z axis. In the description below, φᵢ is decomposed into two angles, φᵢₓ and φ_{iy}, where φᵢₓ is the incidence angle in the z-x plane, and φ_{iy} is the incidence angle in the z-y plane. For clarity of presentation, only φ_{iy} is illustrated in FIG. 1.

The grating has a periodic linear structure along a vector g, forming an angle θ_{R} with the y axis. The period of the grating (also known as the grating pitch) is denoted by D. The grating is formed on a light transmissive substrate having an index of refraction denoted by n_{S}.

Following diffraction by grating 2, wavefront 1 changes its direction of propagation. The principal diffraction direction which corresponds to the first order of diffraction is denoted by d and illustrated as a dashed line in FIG. 1. Similarly to the angle of incidence, the angle of diffraction φ_{d}, is measured between the vector d and the z axis, and is decomposed into two angles, φ_{dx} and φ_{dy}, where φ_{dz} is the diffraction angle in the z-x plane, and φ_{dy} is the diffraction angle in the z-y plane.

The relation between the grating vector g, the diffraction vector d and the incident vector i can therefore be expressed in terms of five angles (θ_{R}, φᵢₓ, φ_{iy}, φ_{dx} and φ_{dy}) and it generally depends on the wavelength λ of the light and the grating period D through the following pair of equations:

sin(φᵢₓ)−n_{S} sin(φ_{dx})=(λ/D)sin(θ_{R}) (EQ. 2)

sin(θ_{iy})+n_{S} sin(θ_{dy})=(λ/D)cos(θ_{R}). (EQ. 3)

Without the loss of generality, the Cartesian coordinate system can be selected such that the vector i lies in the y-z plane, hence sin(φᵢₓ)=0. In the special case in which the vector g lies along the y axis, θ_{R}=0° or 180°, and Equations 2-3 reduce to the following one-dimensional grating equation:

sin φ_{iy}+n_{S} sin φ_{dy}=±λ/d. (EQ. 4)

According the known conventions, the sign of φᵢₓ, φ_{iy}, φ_{dx} and φ_{dy} is positive, if the angles are measured clockwise from the normal to the grating, and negative otherwise. The dual sign on the RHS of the one-dimensional grating equation relates to two possible orders of diffraction, +1 and −1, corresponding to diffractions in opposite directions, say, “diffraction to the right” and “diffraction to the left,” respectively.

A light ray, entering a substrate through a grating, impinge on the internal surface of the substrate opposite to the grating at an angle which depends on the two diffraction components sin(φ_{dx}) and sin(φ_{dy}) according to the following equation:

φ_{d}=sin⁻¹{[sin²(φ_{dx})+sin²(φ_{dy})]^{1/2}} (EQ. 5)

When φ_{d} is larger than the critical angle α_{c}, the wavefront undergoes total internal reflection and begin to propagate within the substrate.

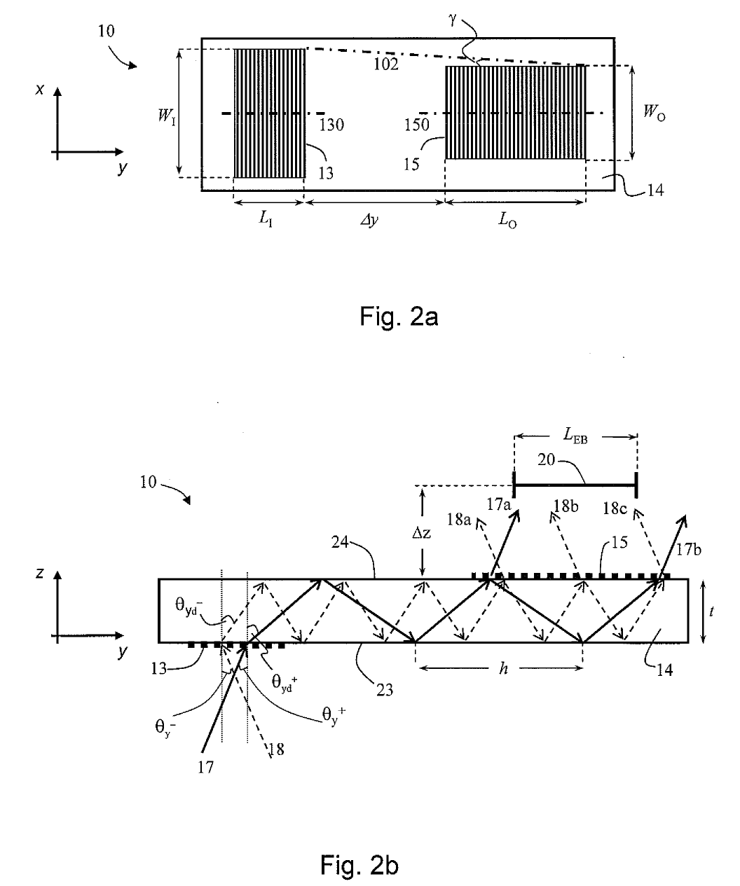

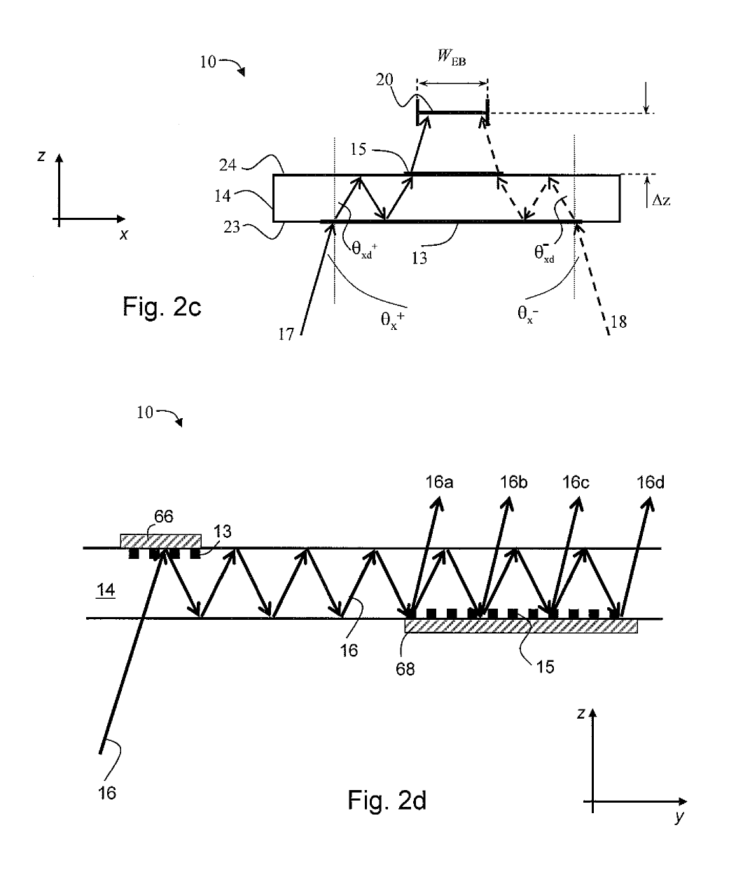

Reference is now made to FIGS. 2a-c which are schematic illustrations of cross sectional views of an optical relay device 10, according to various exemplary embodiments of the present invention. FIGS. 2a, 2b and 2c illustrate cross sectional views of device 10 in the x-y plane, y-z plane and the x-z plane, respectively. According to a preferred embodiment of the present invention device 10 comprises a light-transmissive substrate 14, one or more input optical elements 13 and one or more output optical elements 15. The system of coordinates in FIGS. 2a-c is selected such that substrate 14 is orthogonal to the z axis, and optical elements 13 and 15 are laterally displaced along the y axis. The z axis is referred to as the “longitudinal” axis, and the x and y axes are referred to as the “transverse” axes. Thus, substrate 14 engages the transverse plane spanned by the x-y axes.

Element 13 diffracts the light into substrate 14 such that at least a few light rays experience total internal reflection and propagate within substrate 14. Element 15 serves for diffracting at least a few of the propagating light rays out of substrate 14.

The term “diffract” or “diffraction” as used herein, refers to a change in the propagation direction of a wavefront, in either a transmission mode or a reflection mode. In a transmission mode, “diffract” or “diffraction” refers to change in the propagation direction of a wavefront while passing through the diffractive element; in a reflection mode, “diffract” or “diffraction” refers to change in the propagation direction of a wavefront while reflecting off the diffractive element at an angle different from the basic reflection angle (which is identical to the angle of incidence).

In the exemplified illustrations of FIGS. 2b-c, elements 13 and 15 are transmissive elements, i.e., they operates in transmission mode. A representative illustration in the z-y plane of device 10 according to an embodiment in which elements 13 and 15 operate in a reflection mode is provided in FIG. 2d. Optionally and preferably, one or more of the reflective elements is coated by a reflective coat 66, 68 for reducing optical losses by preventing transmission of light through the element.

Input element 13 is preferably designed and constructed such that the angle of light rays redirected thereby is above the critical angle, and the light propagates in the substrate via total internal reflection. While propagating, the rays are reflected from the internal surfaces of substrate 14. The Euclidian distance between two successive points on the internal surface of the substrate at which a particular light ray experiences total internal reflection is referred to as the “hop length” of the light ray and denoted by “h”. The propagated light, after a few reflections within substrate 14, generally along the horizontal axis of device 10, reaches output optical element 15 which diffracts the light out of substrate 14.

Typically, once a light ray impinges on element 15 only a portion of its energy exits the substrate by diffraction while the remnant of the ray is further reflected within the substrate. The remnant of each ray is redirected by element 15 at an angle, which causes it, again, to experience total internal reflection from the other side of the substrate. After a first reflection, the remnant may re-strike element 15, and upon each such re-strike, an additional part of the light energy exits the substrate.

Thus, a light ray propagating in the substrate via total internal reflection exits the substrate in a form of a series of parallel light rays where the distance between two adjacent light rays in the series is h.

A light ray is mathematically described as a one-dimensional mathematical object. As such, a light ray intersects any surface which is not parallel to the light ray at a point. A light beam is typically described as a plurality of light rays which can be parallel, in which case the light beam is said to be collimated, or non-parallel, in which case the light beam is said to be non-collimated. A light beam therefore intersects a surface which is not parallel to the beam's axis at a plurality of points, one point for each light ray of the beam.

Since more than one light ray exit the substrate as a series of parallel light rays, a beam of light passing through device 10 is expanded in a manner that the cross sectional area of the outgoing beam is larger than cross sectional area of the incoming beam.

Diffraction elements such as elements 13 and 15 are typically characterized by a diffraction efficiency which is defined as the fraction of light energy being diffracted by the element. For a uniform diffraction efficiency of output element 15, each light ray of the series exits with a lower intensity compared to the preceding light ray. For example, suppose that the diffraction efficiency of element 15 for a particular wavelength is 50% (meaning that for this wavelength 50% of the light energy is diffracted at each diffraction occurrence). In this case, the first light ray of the series carries 50% of the original energy, the second light ray of the series carries less than 25% of the original energy and so on. This results in a light beam having a nonuniform profile.

The present embodiments successfully provide techniques for controlling the profile of the outgoing light beam.

Generally, the profile of a light beam is the distribution of an optical characteristic (color, intensity, phase, brightness, hue, saturation, etc.) or a collection of optical characteristics over the locus of all such intersecting points. Typically, but not obligatorily, the profile of the light beam is measured at a planar surface which is substantially perpendicular to the propagation direction of the light.

A profile relating to a specific optical characteristic is referred to herein as a specific profile and is termed using the respective characteristic. Thus, the term “color profile” refers to the color (expressed, e.g., as a coordinate in the CIE space) of the locus of all the intersecting points, the term “intensity profile” refers to the intensity of the locus of all the intersecting points, and so on.

The present inventors have discovered that it is sufficient to control the color profile over a part of the beam's cross section, e.g., less than about 80% or less than about 50% of the beam's cross sectional area. This is particularly useful in applications in which only part of the light beam arrives to the eyes of the user, in which case controlling the color profile across the respective part of the beam can significantly reduce color aberrations. For example, it was found by the present inventors that it is sufficient to reduce color aberrations across a two-dimensional region 20 being at a predetermined distance Δz from light transmissive substrate 14. When relay device 10 is used for human vision (e.g., for viewing a virtual image of an object), the user may place his or her eye(s) within region 20 to view the virtual image. Thus, in these embodiments, region 20 is the so called “eye-box” of device 10, and Δz is approximately the distance between the pupil(s) of the user to substrate 14. The distance Δz is referred to herein as the characteristic eye-relief of device 10.

Thus, in various exemplary embodiments of the invention at least one of substrate 14 input element 13 and output element 15 is designed and constructed to relay at least a portion of the light beam emanating from the object to region 20, such that for each point of the object there is a set of parallel outgoing light rays originating from the point and arriving to region 20. Each such set of outgoing light rays is preferably characterized in that the color difference between the colors of any two outgoing light rays of the set is substantially small. Such configuration significantly reduces color aberrations, because the perception of each point of the object is substantially uniform across region 20.

In some situations, exemplary embodiments of the invention also contemplate small color difference between the colors of outgoing rays belonging to different sets. For example, when there are two or more points of the object with the same color, it is desirable to preserve this property while transmitting the image of the object to region 20. Thus, in various exemplary embodiments of the invention there is a substantially small color difference between the colors of any two outgoing light rays which originate from points of the object having the same color and which enter region 20.

Optionally and preferably, the light beam is relayed such that, in terms of the color profile, there is a minimal or no difference between the original image and the image as perceived by the viewer, apart for overall optical power redaction due to optical losses.

In some embodiments of the invention, the collection of all the aforementioned sets of light rays only forms a part of the outgoing light beam. In these embodiments, there are outgoing light rays which originate from one or more points of the object but do not arrive to region 20. Referring to FIG. 2b, for example, an incoming ray 17 enters substrate 14 via element 13 and exits substrate 14 via element 15 in a form of two outgoing light rays 17a and 17b, but only outgoing ray 17a successfully arrive at region 20. Similarly, an incoming ray 18 enters the substrate via element 13 and exits the substrate via element 15 in a form of three outgoing light rays 18a, 18b and 18c, but only two outgoing rays (18a and 18b) successfully arrive at region 20.

Color difference is conveniently expressed herein by quantities which can be calculated using mathematical operations in the CIE (L*, a*, b*) color space. When the color profile of the beam is expressed in terms of other color spaces (e.g., RGB, CMYK or CIE XYZ) the color difference can be expressed in those color spaces, or, alternatively, the respective color space can be transformed to the CIE (L*, a*, b*) color space to allow the calculation of the color difference in this space. Such type of color transformations are well known to those having ordinary skill in the art of optics. For example, transformation of X, Y and Z tristimulus values to L*, a* and b* coordinates can be done using a preselected white-point (X_{W}, Y_{W}, Z_{W}) which, in some embodiments of the present invention, can be approximated as (X_{W}, Y_{W}, Z_{W})=(1.5193, 1.6841, 1.6514).

The CIE (L*, a*, b*) color space is commonly referred to as a “uniform” color space in that steps of equal size from one color point to another in the color space are perceived approximately as equal differences in color. Every color is treated as a point in the color space and represented by the triplet (L*, a*, b*). The difference between two colors can be quantified using the Euclidian distance between the corresponding points in the color space. Formally, denoting the coordinates of two colors by (L₁*, a₁*, b₂*) and (L₂*, a₂*, b₃*), the difference between the two colors is given by:

ΔE*=\sqrt{(L₁*−L₂*)²+(a₁*−a₂*)²+(b₁*−b₂*)²} (EQ. 6)

Using Equation 6, the color difference between two colors can be expressed in terms of the so called “ΔE* unit.” Thus, for example, the color difference between two colors is said to be 1 ΔE* unit if the right hand side of Equation 6 as calculated for the two colors is unity.

In various exemplary embodiments of the invention, for each set of parallel outgoing light rays arriving to region 20, the color difference between the colors of any two outgoing light rays of the set is less than 50 ΔE* units, more preferably less than 40 ΔE* units, more preferably less than 30 ΔE* units, more preferably less than 20 ΔE* units.

For a given color profile, each color can be associated with a color deviation, σ, which is defined as the Euclidian distance in the CIE (L*, a*, b*) space between the respective color and the average color of the profile, according to the following formula

σ\sqrt{(L*− L̅*)²+(a*−ā*)²+(b*− b̅*)²} (EQ. 7)

where the triplet ( L̅*, ā*, b̅*) represents the average color of the profile. Since the average color is a color by itself, the color deviation σ can be regarded as a type of a color difference hence can be also expressed in terms of ΔE* units. Thus, for example, the color deviation σ of a given color is said to be 1 ΔE* unit if the color difference between the color and the average color is 1 ΔE* unit.

In various exemplary embodiments of the invention, when a uniform white light is relayed by device 10, the color profile across region 20 is also uniform. Preferably, for uniform incoming white beam, the color profile across region 20 is characterized by a maximal color deviation σ_{MAX} which is less than 50 ΔE* units, more preferably less than 40 ΔE* units, more preferably less than 30 ΔE* units, more preferably less than 20 ΔE* units.

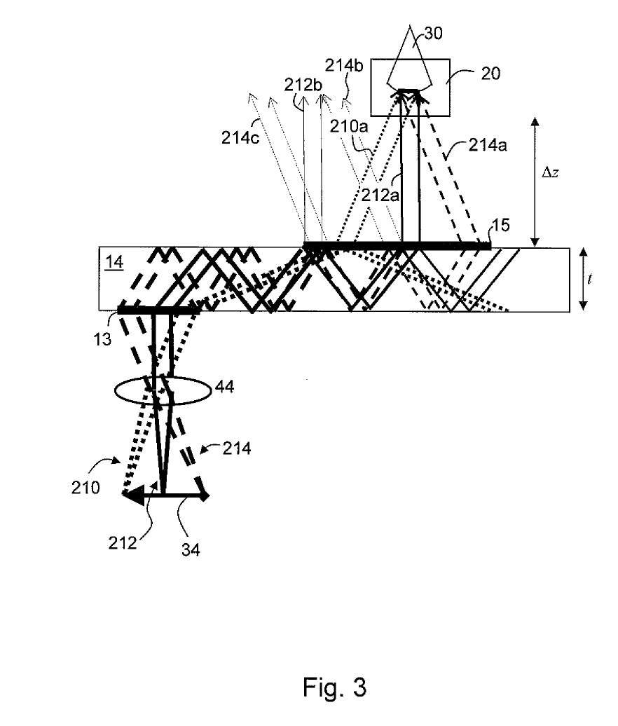

Reference is now made to FIG. 3 which is a schematic illustration of ray propagation in relay device 10, according to various exemplary embodiments of the present invention. Shown in FIG. 3 are several light rays emanating from an object 34. Object 34 is illustrated as an arrow. For clarity of presentation, only three pairs of light rays are shown, but as will be appreciated by one of ordinary skill in the art, there are many more light rays, and the ordinarily skilled person, provided with the present specification, would know how to draw additional emanating light rays. The three pairs of light rays are designated by reference numerals 210 (dotted lines), 212 (continuous lines) and 214 (dashed lines). Pair 210 emanates from the head of the arrow representing object 34, pair 212 emanates from the middle of the arrow, and pair 214 emanates from the tail of the arrow.

The light rays are collimated by a collimator 44 such that the rays of each pair impinge on input element 13 at the same angle (but different pairs impinge at different angles). Once diffracted by element 13, the light rays propagate in substrate 14 via total internal reflection, arrive at element 15 and exit the substrate at a plurality of points along element 15. Some of the outgoing light rays enter region 20 and while other outgoing rays propagate without intersecting with region 20. Preferably, for every point in object 34 there is at least one outgoing light ray which enters region 20. Thus, the user can place his/her eye 30 within region 20 to receive an image of object 34 on his retina. As shown, the diffractive elements preserve relative angles of the light rays. More specifically, the exit angle of the ray substantially equals the angle at which the ray had struck the substrate.

While the color profile is not necessarily uniform across the entire output element, there is a substantially uniform color profile when considering all outgoing light rays across region 20 which originate from the same point of object 34. In other words, there is a substantially small color difference between any two outgoing light rays which image the same point of the object into the eye-box. Yet, the color difference between outgoing light rays which do not enter the eye-box or between outgoing light rays which image different points of the object is not necessarily small.

As known in the art, the intensity of the light is folded into the coordinates in the CIE (L*, a*, b*) color space. Thus, the small color difference between outgoing light rays imaging the same point of the object into correspond to a substantially flat light profile both in terms of the intensity of the light and in terms of the wavelength of the light. The present embodiments are therefore suitable for monochromatic as well as polychromatic light beams.

Suppose that each pair has a different color. For example, suppose that pair 210 is a pair of blue light rays, pair 212 is a pair of green light rays and pair 214 is a pair of red light rays. Since diffractive elements response differently to different colors and different impingement angles, the diffraction angles of light rays emanating from different points of object 34 are generally different.

Consider, for example, pair 212 representing a plurality of light rays emanating from a single point at the middle of object 34. Once emanating, both rays in pair 212 have the same color (green in the present example). The rays exit the collimator parallel to each other and are relayed by relay device 10. In the exemplified illustration shown in FIG. 3, each ray in pair 212 impinges on element 15 twice, and at each impingement part of the energy of the light exits the substrate. There are therefore two pairs of outgoing light rays 212a and 212b which originate from incoming pair 212, of which only pair 212a enters region 20 hence image the middle of object 34 onto region 20. However, other light rays, originating from other points the object and having different colors are also relayed by device 10. Since the diffraction depends on the angle of impingement as well as the color, some other outgoing light rays may mix with the light rays originating from pair 212.

In preferred embodiment of the present invention, the nonuniform diffraction efficiency of element 15 and/or element 13 is selected such that the color difference ΔE* between the rays in pair 212a is sufficiently small, say less than 50 ΔE* units. Yet, in the design of element 15 and/or element 13, no considerations are typically required regarding the color difference between the rays in pair 212b.

A similar description applies, mutatis mutandis, to pairs 214 and 210. For pair 214 (red color), the exemplified illustration of FIG. 3 shows three outgoing pairs, of which only 214a enters into region 20. For pair 210 (blue color) there is a single outgoing pair 210a entering region 20. The color difference between the individual rays in each of pairs 214a and 210a is preferably sufficiently small.

For a given geometrical configuration (e.g., positions and/or dimensions of the substrate and diffractive elements) color aberrations across region 20 can be reduced by a judicious selection of the diffraction efficiency of the diffractive elements. In some embodiments of the present invention, the diffraction efficiency of the input element is substantially uniform, and the diffraction efficiency of the output element is nonuniform. In other embodiments, the diffraction efficiency of the output element is substantially uniform, and the diffraction efficiency of the input element is nonuniform. In additional embodiments the diffraction efficiencies of both output and input elements are nonuniform.

Element 13 and/or element 15 is optionally and preferably a linear diffraction grating, operating according to the diffraction principles described above. When both elements 13 and 15 are linear ratings, their periodic linear structures are preferably substantially parallel.

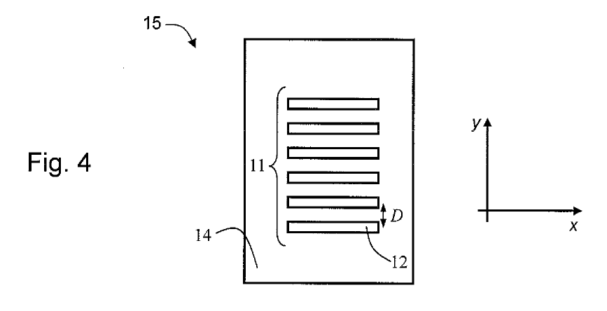

FIG. 4 is a schematic illustration of a top view of diffractive optical element 15, according to various exemplary embodiments of the present invention. Element 15 preferably comprises a grating 12 which can be formed in or attached to light transmissive substrate 14. Grating 12 has a periodic linear structure 11 in one or more directions. In the representative illustration of FIG. 4 the periodic linear structure is along the y direction.

Grating 12 is preferably described by a nonuniform diffraction efficiency function.

The term “nonuniform,” when used in conjunction with a particular observable characterizing the grating (e.g., diffraction efficiency function, duty cycle, modulation depth), refers to variation of the particular observable along at least one direction, and preferably along the same direction as the periodic linear structure (e.g., the y direction in the exemplified illustration of FIG. 4).

Several techniques are contemplated to control the uniformity of the beam exiting the grating. International Patent Application Publication No. WO2007/031992 to Itzkovitch et al., for example, discloses the use of variable duty cycle or variable modulation depth of the grating in order to achieve uniform intensity across the grating. According to the teachings of Itzkovitch et al., the grating is divided into N segments, such that the diffraction efficiency of the kth segment (1≦k≦N) is 1/k. When N approximately equals the ratio between the width of the grating and the characteristic hop length of a particular wavelength, a uniform intensity is provided for the particular wavelength across the entire grating. The reason is that at each impingement on the grating, the fraction of the ray's energy which exits the substrate by diffraction is 1/N (the first segment diffracts out 1/N of the energy, the second segment diffracts out (1−1/N)/(N−1)=1/N, the third segment diffracts out (1−2/N)/(N−2)=1/N, etc.).

In some embodiments of the present invention, linear structure 11 of grating 12 is characterized by nonuniform duty cycle selected such as to reduce color differences between incoming light rays and corresponding outgoing light rays which ultimately arrive at region 20.

As used herein, “duty cycle” is defined as the ratio of the width, W, of a ridge in the grating to the period D.

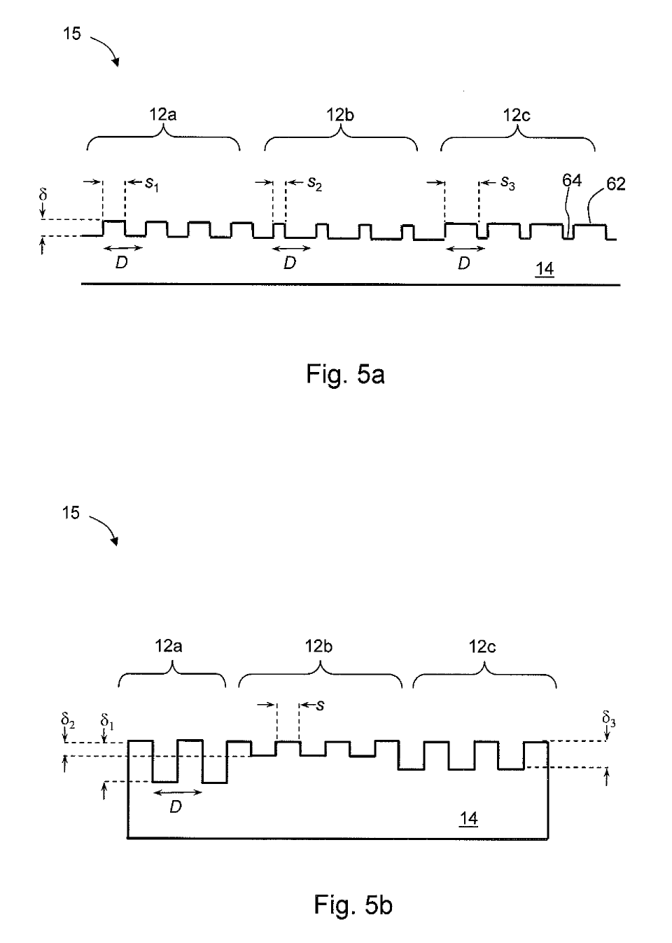

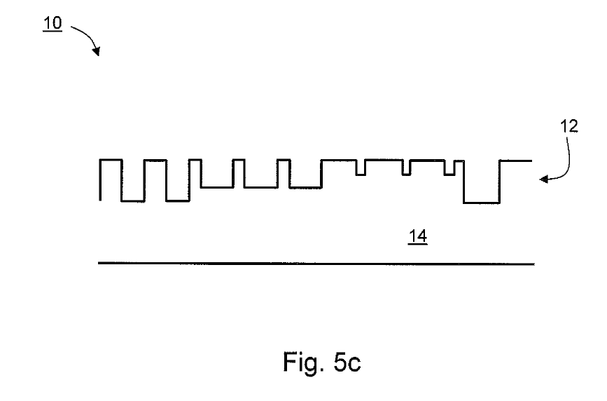

A representative example of element 10 in the preferred embodiment in which grating 12 has nonuniform duty cycle is illustrated in FIG. 5a. As shown grating 12 comprises a plurality of ridges 62 and grooves 64. In the exemplified illustration of FIG. 5a, the ridges and grooves of the grating form a shape of a square wave. Such grating is referred to as a “binary grating”. Other shapes for the ridges and grooves are also contemplated. Representative examples include, without limitation, triangle, saw tooth and the like.

FIG. 5a exemplifies an embodiment in which grating 12 comprises several concatenated segments, all having the same period. Three segments 12a, 12b and 12c are shown in FIG. 5a, but this need not necessarily be the case, since, for some applications, it may be desired to concatenate a different number of segments. Further, although the concatenated segment shown as having different ridge widths, this need not necessarily be the case, since in some applications two or more adjacent segments can have the same ridge width. In segment 12a, the width of the ridges is s₁, hence the duty cycle is s₁/D; in segment 12b, the width of the ridges is s₂, hence the duty cycle is s₂/D; and in segment 12c, the width of the ridges is s₃, hence the duty cycle is s₃/D.

As demonstrated in the Examples section that follows, a judicious selection of the duty cycle at each region of grating 12 can provide a substantially uniform color profile across the eye-box of the relay device, for a white incoming light beam.

Linear grating having a nonuniform duty cycle suitable for the present embodiments is preferably fabricated utilizing a technology characterized by a resolution of 50-100 nm. For example, grating 12 can be formed on a light transmissive substrate by employing a process in which electron beam lithography is followed by etching. A process suitable for forming grating having a nonuniform duty cycle according to embodiments of the present invention may be similar to and/or be based on the teachings of U.S. patent application Ser. No. 11/505,866, assigned to the common assignee of the present invention and fully incorporated herein by reference.

An additional embodiment for achieving nonuniform diffraction efficiency function includes a linear structure characterized by nonuniform modulation depth.

FIG. 5b exemplifies an embodiment in which grating 12 comprises different segments, where in each segment the ridges and grooves of grating 12 are characterized by a different modulation depth. The three segments 12a, 12b and 12c have identical duty cycles s/D, but their modulation depths differ. The modulation depth of segments 12a, 12b and 12c are denoted δ₁, δ₂ and δ₃, respectively. Also contemplated are configurations in which two or more adjacent segments have the same modulation depths.

In another embodiment, illustrated in FIG. 5c, the linear structure of the grating is characterized by nonuniform modulation depth and nonuniform duty-cycle, where the nonuniform duty cycle is selected in combination with the nonuniform modulation depth to provide the desired nonuniform diffraction efficiency function. The combination between nonuniform duty cycle and nonuniform modulation depth significantly improves the ability to accurately design the grating in accordance with the required profile, because such combination increases the number of degrees of freedom available to the designer.

In any one of the above embodiments the number, size and diffraction efficiency of the individual segments of the input and/or output gratings can be optimized so as to reduce color aberrations across region 20 (but not necessarily across the entire output elements). Each segment of the grating can have a specific diffraction efficiency which may or may not be equal to the diffraction efficiency of the adjacent segment(s). The diffraction efficiency of each segment can be realized by any parameter or combination of parameters selected from the group consisting of modulation depth, duty cycle and/or grating profile.

Without being bound to any theory, the optimization can reduce color losses during the transmission of image to region 20. For example, the present Inventors discovered that when the length of the output element is much larger than the length of the eye-box region traditional techniques (e.g., the 1/k diffraction efficiency technique), can generate a substantial amount of optical loss. According to the teachings of the present embodiments, there is no need to provide uniform output across the entire output elements. The amount of optical power delivered to the eye-box can therefore be increased on the expense of reduced power at light rays which do not reach the eye-box.

In various exemplary embodiments of the invention the number of segments is large, preferably more than four segments, e.g., about eight segments or more. The length of the segments can be the same for two or more segments (e.g., the same length for all segments), or it can vary (monotonically or not) across the length of the grating.

The number of segments can also be selected based on the typical hop-length of light rays within the device. In this embodiment, the length of each segment equals or is smaller than the typical hop-length, and the number of segments, for a given length of the grating, can be selected to fulfill this criterion.

In an alternative embodiment, the number of segments is selected based on the typical diameter of the human's pupil. In this embodiment, the length of each segment is smaller than the minimal opening of the pupil, which is approximately 3 mm. The number of segments, for a given length of the grating, can then be selected to fulfill this criterion.

Also contemplated is an embodiment in which the width of one or more segments equals the period of the grating. For example, the grating can include P periods each being treated as a segment of the grating. Thus, the present embodiments contemplate a grating in which the diffraction efficiency of at least one period differs from the diffraction efficiency of the periods adjacent thereto.

A method suitable for selecting the grating parameters of the input and/or output gratings is provided hereinunder.

Elements 13 and 15 can be formed on or attached to any of the surfaces 23 and 24 of substrate 14. Substrate 14 can be made of any light transmissive material, preferably, but not obligatorily, a martial having a sufficiently low birefringence. Element 15 is laterally displaced from element 13. A preferred lateral separation between the elements is from a few millimeters to a few centimeters.

Device 10 is preferably designed to transmit light striking substrate 14 at any striking angle within a predetermined range of angles, which predetermined range of angles is referred to as the field-of-view of the device.

The input optical element is preferably designed to trap all light rays in the field-of-view within the substrate. A field-of-view can be expressed either inclusively, in which case its value corresponds to the difference between the minimal and maximal incident angles, or explicitly in which case the field-of-view has a form of a mathematical range or set. Thus, for example, a field-of-view, Ω, spanning from a minimal incident angle, α, to a maximal incident angle, β, is expressed inclusively as Ω=β−α, and exclusively as Ω=[α, β]. The minimal and maximal incident angles are also referred to as rightmost and leftmost incident angles or counterclockwise and clockwise field-of-view angles, in any combination. The inclusive and exclusive representations of the field-of-view are used herein interchangeably.

Referring again to FIGS. 2a-d, the field-of-view of device 10 is illustrated in FIGS. 2b and 2c above by two of its outermost light rays, generally shown at 17 and 18. FIGS. 2b and 2c illustrate the projections of rays 17 and 18 on two planes which are parallel to the normal axis of device 10. Specifically, FIG. 2b illustrates the projections of rays 17 and 18 on a plane containing the horizontal axis of device 10 (the y-z plane in the present coordinate system) and FIG. 2c illustrates the projections of rays 17 and 18 on a plane containing the vertical axis of device 10 (the x-z plane in the present coordinate system).

Below, the term “horizontal field-of-view” will be used to describe the ranges angles within the field-of-view as projected on the y-z plane, and the term “vertical field-of-view” or “vertical field-of-view” will be used to describe the ranges angles within the field-of-view as projected on the x-z plane.

Thus, FIG. 2b schematically illustrates the horizontal field-of-view and FIG. 2c schematically illustrates the vertical field-of-view of device 10. In the horizontal field-of-view illustrated in FIG. 2b, the projection of ray 18 is the rightmost ray projection which forms with the normal axis an angle denoted θ_{y}⁻, and the projection of ray 17 is the leftmost ray projection which forms with the normal axis an angle denoted θ_{y}⁺. In the vertical field-of-view illustrated in FIG. 2c, the projection of ray 18 is the rightmost ray projection which forms with the normal axis an angle denoted θₓ⁻ and the projection of ray 17 is the leftmost ray projection which forms with the normal axis an angle denoted θₓ⁺. When substrate 14 is held with the vertical axis directed upwards, the projection of ray 18 is viewed as the uppermost ray projection and the projection of ray 17 is viewed as the lowermost ray projection.

In exclusive representations, the horizontal field-of-view, denoted Ω_{y}, is [θ_{y}⁻, θ_{y}⁺] and the vertical field-of-view, denoted Ωₓ is [θₓ⁻, θₓ⁺]. In the exemplified illustration of FIGS. 2b and 2c the projections θₓ⁻, θ_{y}⁻ are measured anticlockwise from the normal axis (the z axis in FIGS. 2b and 2c), and the projections θ⁺ₓ, θ⁺_{y} are measured clockwise from the normal axis. Thus, according to the above convention, θₓ⁻, θ_{y}⁻ have negative values and θ⁺ₓ, θ⁺_{y} have positive values, resulting in a horizontal field-of-view Ω_{y}=θ_{y}⁺+|θ_{y}⁻|, and a vertical field-of-view Ωₓ=θ⁺+|θₓ⁻|, in inclusive representations.

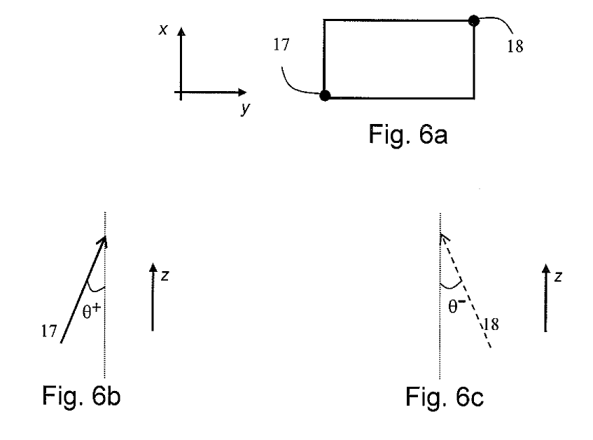

FIG. 6a schematically illustrates the field-of-view in a plane orthogonal to the normal axis of device 10 (parallel to the x-y plane, in the present coordinate system). Rays 17 and 18 are points on this plane. For the purpose of simplifying the presentation, the field-of-view is illustrated as a rectangle, and the straight light connecting the points is the diagonal of the rectangle. Rays 17 and 18 are referred to as the “lower-left” and “upper-right” light rays of the field-of-view, respectively.

It is appreciated that the field-of-view can also have a planar shape other than a rectangle, include, without limitation, a square, a circle and an ellipse. One of ordinary skills in the art, provided with the details described herein would know how to adjust the description for non-rectangle field-of-view.

In exclusive representation, the diagonal field-of-view of device 10 is given by Ω=[θ⁻, θ⁺], where θ⁻ the angle between ray 17 and a line intersecting ray 17 and being parallel to the normal axis, and θ⁺ is the angle between ray 18 and a line intersecting ray 18 and being parallel to the normal axis. FIGS. 6b and 6c illustrate the diagonal field-of-view angles θ⁻ and θ⁺ in planes containing ray 17 and ray 18, respectively. The relation between θ^{±} and their projections θₓ^{±}, θ_{y}^{±} are given by Equation 5 above with the substitutions φ_{dx}→θₓ^{±} and φ_{dy}→θ_{y}^{±}. Unless specifically stated otherwise, the term “field-of-view angle” refers to a diagonal angle, such as θ^{±}.

The light rays arriving to device 10 can have one or more wavelength. When the light has a plurality of wavelengths, the shortest wavelength is denoted λ_{B} and the longest wavelength is denoted λ_{R}, and the range of wavelengths from λ_{B} to λ_{R} is referred to herein as the spectrum of the light.

Irrespectively of the number of different wavelengths of the light, when the light rays in the field-of-view impinge on element 13, they are preferably redirected at an angle (defined relative to the normal) which is larger than the critical angle, such that upon striking the other surface of substrate 14, all the light rays of the field-of-view experiences total internal reflection and propagate within substrate 14.

In the representative illustration of FIGS. 2b-c, element 13 diffracts leftmost ray 17 and rightmost ray 18 into substrate 14 at diffraction angles denoted θ_{d}⁺ and θ_{d}⁻, respectively. Shown in FIGS. 2b-c are θ_{yd}^{±} (FIG. 2b) and θ_{xd}^{±} (FIG. 2c), which are the projections of θ_{d}^{±} on the y-z plane and the x-z plane, respectively.

In various exemplary embodiments of the invention device 10 transmits at least a portion of the optical energy carried by each light ray between rays 17 and 18. When the light rays within the field-of-view originate from an object which emits or reflects light, a viewer can position one or two eyes in region 20 to see a virtual image of the object.

According to a preferred embodiment of the present invention output optical element 15 is characterized by planar dimensions selected such that at least a portion of one or more outermost light rays within the field-of-view is directed to region 20.

To ensure entering of the outermost light ray or the entire outgoing light beam into region 20, the length L_{O} of element 15 is preferably selected to be larger then a predetermined length threshold, L_{O, min}, and the width W_{O} of element 15 is preferably selected to be larger then a predetermined width threshold, W_{O, min}. In various exemplary embodiments of the invention the length and width thresholds are given by the following expressions:

L_{O}, ₘᵢₙ=2Δz tan(Ω_{y}/2)

W_{O}, ₘᵢₙ=2Δz tan(Ωₓ/2). (EQ. 8)

For transmitting an image to one eye, the length L_{O} and width W_{O} of element 15 are preferably about L_{O}, ₘᵢₙ+Oₚ, and about W_{O}, ₘᵢₙ+Oₚ, respectively, where Oₚ represents the diameter of the pupil and is typically about 3 millimeters. In various exemplary embodiments of the invention the eye-box is larger than the diameter of the pupil, so as to allow the user to relocate the eye within the eye-box while still viewing the entire virtual image. Thus, denoting the dimensions of region 20 by L_{EB} and W_{EB}, where L_{EB} is measured along the y axis and W_{EB} is measured along the x axis, the length and width of element 15 are preferably:

L_{O}=L_{O}, ₘᵢₙ+L_{EB}

W_{O}=W_{O}, ₘᵢₙ+W_{EB}, (EQ. 9)

where each of L_{EB} and W_{EB} is preferably larger than Oₚ, so as to allow the user to relocate the eye within region 20 while still viewing the entire field-of-view.

The dimensions of input optical element 13 are preferably selected to allow all light rays within the field-of-view to propagate in substrate 14 such as to impinge on the area of element 15. In various exemplary embodiments of the invention the length L_{I} of input element 13 equals from about X to about 3X where X is preferably a unit hop-length characterizing the propagation of light rays within substrate 14. Typically, X equals the hop-length of the light-ray with the minimal hop-length, which is one of the outermost light-rays in the field-of-view (ray 18 in the exemplified illustration of FIG. 2b). When the light has a plurality of wavelengths, X is typically the hop-length of one of the outermost light-rays which has the shortest wavelength of the spectrum.

According to a preferred embodiment of the present invention the width W_{O} of element 15 is smaller than the width W_{I} of element 13. W_{I} is preferably calculated based on the relative arrangement of elements 13 and 15. For example, in one embodiment, elements 13 and 15 are centrally aligned with respect to the vertical axis of device 10 (but laterally displaced along the horizontal axis and optionally displaced also along the normal axis). In the present coordinate system this central alignment correspond to equal x coordinate for a central width line 130 (connecting half width points of element 13) and a central width line 150 (connecting half width points of element 15). In this embodiment, the relation between W_{I} is preferably given by the following expression:

W_{I}=2(L_{O}+Δy)tan γ+W_{O}, (EQ. 10)

where Δy is the lateral separation between element 13 and element 15 along the horizontal axis of device 10 and γ is a predetermined angular parameter. Geometrically, γ is the angle formed between the horizontal axis and a straight line connecting the corner of element 13 which is closest to element 15 and the corner of element 15 which is farthest from element 13 (see, e.g., line 102 in FIG. 2a).

Preferably, γ relates to the propagation direction of one or more of the outermost light rays of the field-of-view within the substrate, as projected on a plane parallel to the substrate. In various exemplary embodiments of the invention y equals the angle formed between the horizontal axis of the substrate and the propagation direction of an outermost light ray of the field-of-view, as projected on a plane parallel to the substrate.

Consider, for example, the “upper-right” light ray of the field-of-view impinging on element 13 at a field-of-view angle θ⁻ which is decomposed, according to the Cartesian coordinate system described above, into of angles θₓ⁻ (measured in the x-z plane) and θ_{y}⁻ (measured in the y-z plane). Using Equations 2 and 3 above, the corresponding components θ_{xd} and θ_{yd} of the diffraction angle θ_{d} can be calculated, e.g., by selecting a value of 0° to θ_{R}. The propagation of the “upper-right” light ray in the substrate, can then be projected on a plane parallel to the substrate (the x-y plane in the present coordinate system), thereby forming a vector in the x-y plane. According to a preferred embodiment of the present invention γ is set to the angle formed between the projected vector and the γ axis, which can be written in the form: γ=tan⁻¹[sin(θ_{xd})/sin(θ_{yd})]. A typical value for the absolute value of γ is, without limitation, from about 6° to about 15°.

Thus, a viewer placing his or her eye in region 20 of dimensions L_{EB}×W_{EB}, receives at least a portion of any light ray within the field-of-view, provided the distance between the eye and element 15 equals Δz or is smaller than Δz.

The preferred value for Δz is, without limitation, from about 15 millimeters to about 35 millimeters, the preferred value for Δy is, without limitation, from a few millimeters to a few centimeters, the preferred value for L_{EB} is, without limitation, from about 5 millimeters to about 13 millimeters, and the preferred value for W_{EB} is, without limitation, is from about 4 millimeters to about 9 millimeters. For a given field-of-view, selection of large Δz results in smaller eye-box dimensions L_{EB} and W_{EB}, as known in the art. Conversely, small Δz allows for larger eye-box dimensions L_{EB} and W_{EB}.

L_{O}, ₘᵢₙ and W_{O}, ₘᵢₙ are preferably calculated using Equation 8, and together with the selected dimensions of region 20 (L_{EB} and W_{EB}), the dimensions of element 15 (L_{O} and W_{O}) can be calculated using Equation 9.

Once L_{O} and W_{O} are calculated, the vertical dimension W₁ of input element 13 is preferably calculated by selecting values for Δy and γ and using Equation 10. The horizontal dimension L_{I} is generally selected from about 3 millimeters and about 15 millimeters.

In a preferred embodiment in which surfaces 23 and 24 of substrate 14 are substantially parallel, elements 13 and 15 can be designed, for a given spectrum, solely based on the value of θ⁻ and the value of the shortest wavelength λ_{B}. For example, when the optical elements are linear gratings, the period, D, of the gratings can be selected based on θ⁻ and λ_{B}, irrespectively of the optical properties of substrate 14 or any wavelength longer than λ_{B}.

According to a preferred embodiment of the present invention D is selected such that the ratio λ_{B}/D is from about 1 to about 2. A preferred expression for D is given by the following equation:

D=λ_{B}/[n_{A}(1−sin θ⁻)] (EQ. 11)

It is appreciated that D, as given by Equation 11, is a maximal grating period. Hence, in order to accomplish total internal reflection D can also be smaller than λ_{B}/[n_{A}(1−sin θ⁻)].

Substrate 14 is preferably selected such as to allow light having any wavelength within the spectrum and any striking angle within the field-of-view to propagate in substrate 14 via total internal reflection.

According to a preferred embodiment of the present invention the refraction index of substrate 14 is larger than λ_{R}/D+n_{A} sin(θ⁺). More preferably, the refraction index, n_{S}, of substrate 14 satisfies the following equation:

n_{S}≧[λ_{R}/D+n_{A} sin(θ⁺)]/sin(α_{D}^{MAX}). (EQ. 12)

where α_{D}^{MAX} is the largest diffraction angle, e.g., the diffraction angle of the light ray 17. There are no theoretical limitations on α_{D}^{MAX}, except from a requirement that it is positive and smaller than 90 degrees. α_{D}^{MAX} can therefore have any positive value smaller than 90°. Various considerations for the value α_{D}^{MAX} are found in U.S. Pat. No. 6,757,105, the contents of which are hereby incorporated by reference.

Device 10 is preferably capable of transmitting light having a spectrum spanning over at least 100 nm. More specifically, the shortest wavelength, λ_{B}, generally corresponds to a blue light having a typical wavelength of between about 400 to about 500 nm and the longest wavelength, λ_{R}, generally corresponds to a red light having a typical wavelength of between about 600 to about 700 nm.

The light transmitted through device 10 can carry imagery information. Ideally, a multicolor image is a spectrum as a function of wavelength, measured at a plurality of image elements. This ideal input, however, is rarely attainable in practical systems. Therefore, the present embodiment also addresses other forms of imagery information. A large percentage of the visible spectrum (color gamut) can be represented by mixing red, green, and blue colored light in various proportions, while different intensities provide different saturation levels. Sometimes, other colors are used in addition to red, green and blue, in order to increase the color gamut. In other cases, different combinations of colored light are used in order to represent certain partial spectral ranges within the human visible spectrum.

In a different form of color imagery, a wide-spectrum light source is used, with the imagery information provided by the use of color filters. The most common such system is using white light source with cyan, magenta and yellow filters, including a complimentary black (or neutral density) filter. The use of these filters could provide representation of spectral range or color gamut similar to the one that uses red, green and blue light sources, while saturation levels are attained through the use of different optical absorptive thickness for these filters, providing the well known “grey levels”.

Thus, the multicolored image can be displayed by three or more channels, such as, but not limited to, Red-Green-Blue (RGB) or Cyan-Magenta-Yellow-Black (CMYK) channels. RGB channels are typically used for active display systems (e.g., CRT or OLED) or light shutter systems (e.g., Digital Light Processing™ (DLP™) or LCD illuminated with RGB light sources such as LEDs). CMYK images are typically used for passive display systems (e.g., print). Other forms are also contemplated within the scope of the present invention.

The diffraction efficiency of light depends on the wavelength of the light. When the diffraction effect is used for transmitting light from one location to the other (for example by providing the appropriate condition for total internal reflection to take place), the wavelength dependence of the diffraction efficiency also affects the transmission efficiency of the light. Thus, when a light having a spectrum of wavelength is diffracted through a diffraction grating, some wavelengths of the light are diffracted with lower efficiency than the others.

While conceiving the present invention it was realized by the Inventors, that a chromatic light (such as, for example, a light radiated by a single chromatic image source) can be efficiently transmitted by first decomposing the light into individual sub-spectra and transmitting each sub-spectra using a different optical relay device. The decomposition of the light can be considered as a spectral decomposition in a sense that a chromatic light ray coming from a particular direction is decomposed into two or more light rays each belonging to a different sub-spectrum.

It is to be understood, that the number of sub-spectra does not have to equal the number of individual wavelengths existing in the light ray, although such embodiment is not excluded from the scope of the present invention.

The number as well as the type of the optical relay devices and their component is preferably selected according to the spectral channels used for generating the image. For example, a multicolor image can be provided by an OLED array having red, green and blue organic diodes which are viewed by the eye as continues spectrum of colors due to many different combinations of relative proportions and intensities between the wavelengths of light emitted thereby. For such images, three light transmissive substrates can be used, one for each spectral channel, where each substrate is formed with input/output optical elements designed for the respective spectral channel.

It was found by the Inventors of the preset invention that RGB images can also be efficiently transmitted using only two light transmissive substrates.

This is because the green portion of the spectrum is partially diffracted by the optical device which is designated to the blue and near-blue light, and partially diffracted by the optical device which is designated to the red and near-red light.

Generally, diffractions into and out of the two substrates are complimentary such that overall, high diffraction efficiency and brightness uniformity across the field-of-view is achieved.

In the embodiment in which two sub-spectra are used, one sub-spectrum can include red and near-red wavelengths and one sub-spectrum can include blue and near-blue wavelengths. In the embodiment in which three sub-spectra are used, an additional sub-spectrum can include green and near-green wavelengths. In various exemplary embodiments of the invention there is a certain overlap between the sub-spectra. For example, in the above embodiment of two sub-spectra, the first sub-spectrum can include wavelengths of from about 540 to about 650 nm, corresponding to the red part of the spectrum, and the second sub-spectrum can include wavelengths of from about 460 to about 570 nm, corresponding to the blue part of the spectrum. Thus, in this exemplary embodiment, the two sub-spectra have an overlap of about 30 nm.

In various exemplary embodiments of the invention the optical relay devices used for transmitting the portions of the light are planar optical devices which engage different, preferably parallel, planes. For example, one or more of the optical relay devices can be similar to device 10 described above. Thus, the present embodiments transmit different sub-spectra through different planes. The advantage of transmitting the decomposed light is that the transmission efficiency of each portion of the light can be tailored to its spectral range, thus optimizing the overall transmission efficiency.

A representative example of an optical apparatus operating according to the above principles is provided hereinunder.

As can be understood from the geometrical configuration illustrated, e.g., in FIGS. 2b-c, the angles at which light rays 18 and 17 are redirected can differ. As the angles of redirection depend on the incident angles (see, e.g., Equations 2-5 for the case of diffraction), the allowed clockwise (θ⁺) and anticlockwise (θ⁻) field-of-view angles, are also different. Thus, the relay device of the present embodiments supports transmission of asymmetric field-of-view in which, say, the clockwise field-of-view angle is greater than the anticlockwise field-of-view angle. The difference between the absolute values of the clockwise and anticlockwise field-of-view angles can reach more than 70% of the total field-of-view.

This asymmetry can be exploited in accordance with various exemplary embodiments of the present invention, to enlarge the field-of-view of the optical relay device. According to a preferred embodiment of the present invention, a light-transmissive substrate can be formed with at least one input optical element and two or more output optical elements. The input optical element(s) serve for redirecting the light into the light-transmissive substrate in a manner such that different portions of the light, corresponding to different partial field-of-views, propagate within the substrate in different directions to thereby reach the output optical elements. The output optical elements redirect the different portions of the light out of the light-transmissive substrate.

In accordance with the present embodiments, the planar dimensions of the output and/or input optical elements can be selected to facilitate the transmission of the partial field-of-views. The output optical elements can also be designed and constructed such that the redirection of the different portions of the light is in complementary manner.

The terms “complementarily” or “complementary,” as used herein in conjunction with a particular observable or quantity (e.g., field-of-view, image, spectrum), refer to a combination of two or more overlapping or non-overlapping parts of the observable or quantity, which combination provides the information required for substantially reconstructing the original observable or quantity.

Any number of input/output optical elements can be used. Additionally, the number of input optical elements and the number of output optical elements may be different, as two or more output optical elements may share the same input optical element by optically communicating therewith. The input and output optical elements can be formed on a single substrate or a plurality of substrates, as desired. For example, in one embodiment, the input and output optical elements comprise linear diffraction gratings of identical periods, formed on a single substrate, preferably in a parallel orientation.

If several input/output optical elements are formed on the same substrate, as in the above embodiment, they can engage any side of the substrate, in any combination.

One ordinarily skilled in the art would appreciate that this corresponds to any combination of transmissive and reflective optical elements. Thus, for example, suppose that there is one input optical element, formed on surface 23 of substrate 14 and two output optical elements formed on surface 24. Suppose further that the light impinges on surface 23 and it is desired to diffract the light out of surface 24. In this case, the input optical element and the two output optical elements are all transmissive, so as to ensure that entrance of the light through the input optical element, and the exit of the light through the output optical elements. Alternatively, if the input and output optical elements are all formed on surface 23, then the input optical element remain transmissive, so as to ensure the entrance of the light therethrough, while the output optical elements are reflective, so as to reflect the propagating light at an angle which is sufficiently small to couple the light out. In such configuration, light can enter the substrate through the side opposite the input optical element, be diffracted in reflection mode by the input optical element, propagate within the light transmissive substrate in total internal diffraction and be diffracted out by the output optical elements operating in a transmission mode.

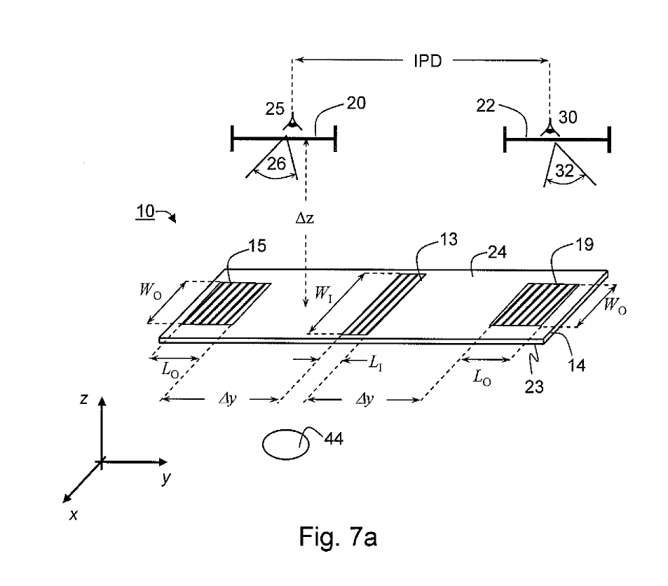

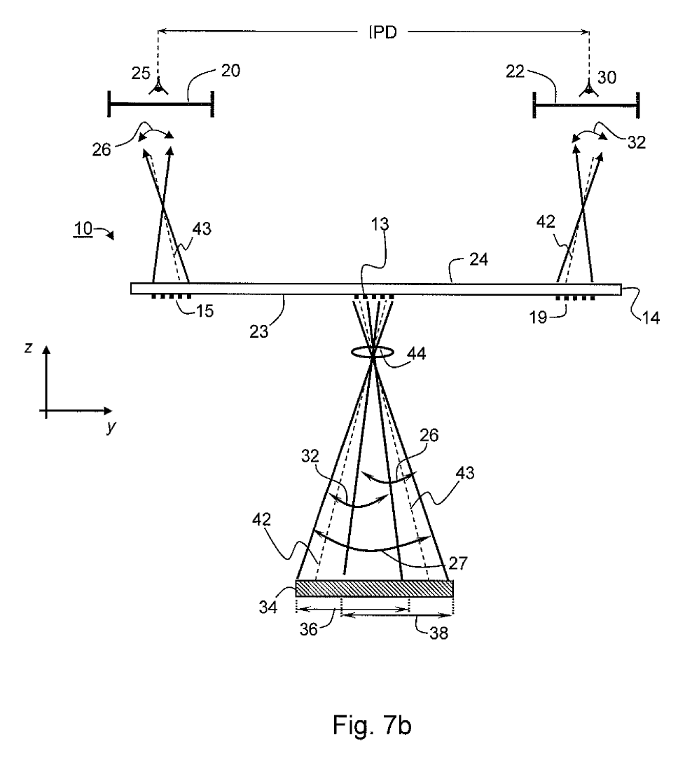

Reference is now made to FIGS. 7a-b which are schematic illustrations of a perspective view (FIG. 7a) and a side view (FIG. 7b) of device 10, in a preferred embodiment in which one input optical element 13 and two output optical elements 15 and 19 are employed. In this embodiment, device 10 can be used as a binocular device for transmitting light to a first eye 25 and a second eye 30 of a user.

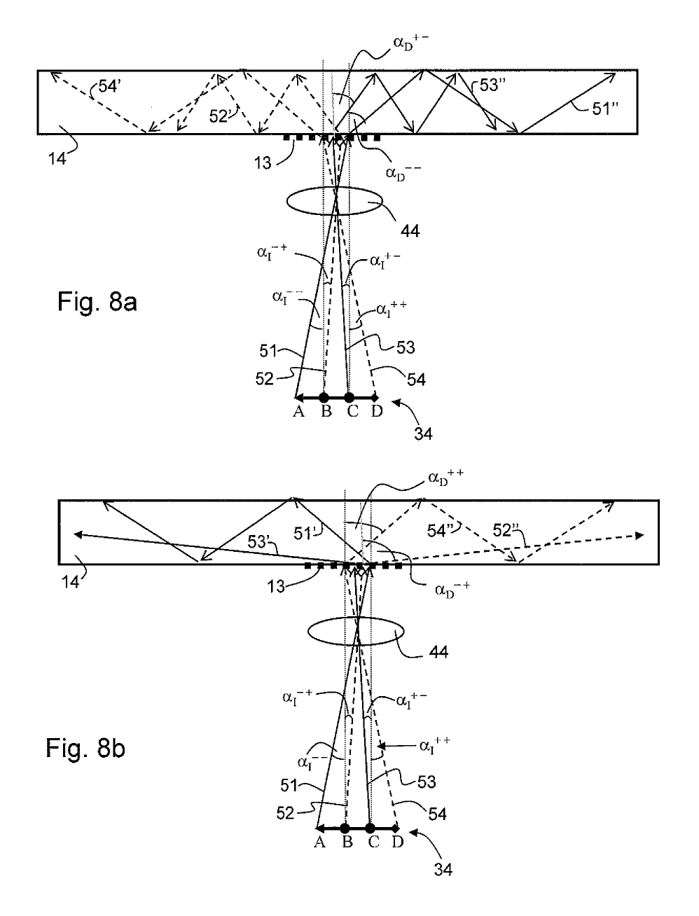

In FIG. 7b, first 15 and second 19 output optical elements are formed, together with input optical element 13, on surface 23 of substrate 14. However, as stated, this need not necessarily be the case, since, for some applications, it may be desired to form the input/output optical elements on any of the surfaces of substrate 14, in an appropriate transmissive/reflective combination. Wavefront propagation within substrate 14, according to various exemplary embodiments of the present invention, is further detailed hereinunder with reference to FIGS. 8a-b.

Element 13 preferably redirects the incoming light into substrate 14 in a manner such that different portions of the light, corresponding to different partial fields-of-view, propagate in different directions within substrate 14. In the configuration exemplified in FIGS. 7a-b, element 13 redirects light rays within one asymmetric partial field-of-view, designated by reference numeral 26, leftwards to impinge on element 15, and another asymmetric partial field-of-view, designated by reference numeral 32, to impinge on element 19. Elements 15 and 19 complementarily redirect the respective portions of the light, or portions thereof, out of substrate 14, to provide first eye 25 with partial field-of-view 26 and second eye 30 with partial field-of-view 32.

Partial field-of-views 26 and 32 form together the field-of-view 27 of device 10. Similarly to the embodiments in which one output optical element is employed (see, e.g., FIGS. 7a-c) elements 15 and 19 are characterized by planar dimensions selected such that at least a portion of one or more outermost light rays within partial field-of-view 26 is directed to two-dimensional region 20, and at least a portion of one or more outermost light rays within partial field-of-view 32 is directed to another two-dimensional region 22. This can be achieved by selecting the lengths and widths of elements 15 and 19 to be larger then predetermined length and width thresholds, as described above (see Equations 8-9).

Preferably, but not obligatorily, the planar dimensions of region 20 equal the planar dimensions of region 22. Thus, the planar dimensions of each of regions 20 and 22 as well as the distance Δz are preferably within the aforementioned ranges.

In various exemplary embodiments of the invention the lateral separation between the horizontal centers of regions 20 and 22 is at least 40 millimeters. Preferably, the lateral separation between the horizontal centers of regions 20 and 22 is less than 80 millimeters. According to a preferred embodiment of the present invention the planar dimensions of elements 15 and 19 are selected such that the portions of outermost light rays are respectively directed to regions 20 and 22, for any lateral separation between the regions which is larger than 40 millimeters and smaller than 80 millimeters.

When device 10 is used for transmitting light to the eyes of the user, the planar dimensions of elements 15 and 19 are preferably selected such that eyes 25 and 30 are respectively provided with partial field-of-views 26 and 32 for any interpupillary distance IPD satisfying IPDₘᵢₙ≦IPD≦IPDₘₐₓ.

This is preferably ensured by selecting the lengths L_{EB} of regions 20 and 22 according to the following weak inequality:

L_{EB}≧(IPDₘₐₓ−IPD_{max)/}2. (EQ. 13)

Once L_{EB} is selected to satisfy Equation 13, the lengths and widths of output elements 15 and 19 can be set according to Equations 9 substantially as described hereinabove. According to a preferred embodiment of the present invention the horizontal center of each of elements 15 and 19 is located at a distance of (IPDₘₐₓ+IPDₘᵢₙ)/4 from the horizontal center element 13.

The width W_{I} of element 13 is preferably larger than width of each of elements 15 and 19. The calculation of W_{I} is preferably, but not obligatorily, performed using a procedure similar to the procedure described above, see Equation 10. When it is desired to manufacture a symmetric optical relay, the same planar dimensions L_{O}×W_{O} are used for both output elements 15 and 19, and the same lateral separation Δy is used between elements 13 and 15 and between elements 13 and 19. In this case, the width W_{I} of the input element can be set according to Equation 10 using the angular parameter γ as described above. Equation 10 can also be used in for configuration in which the lateral separation between elements 13 and 15 differs from the lateral separation between elements 13 and 19. In this case the value of Δy which is used in the calculation is preferably set to the larger of the two lateral separations.

When device 10 is used for transmitting an image 34, field-of-view 27 preferably includes substantially all light rays originated from image 34. Partial fields-of-view 26 and 32 can therefore correspond to different parts of image 34, which different parts are designated in FIG. 7b by numerals 36 and 38. Thus, as shown in FIG. 7b, there is at least one light ray 42 which enters device 10 via element 13 and exits device 10 via element 19 but not via element 15. Similarly, there is at least one light ray 43 which enters device 10 via element 13 and exits device 10 via element 15 but not via element 19.

Generally, the partial field-of-views, hence also the parts of the image arriving to each eye depend on the wavelength of the light. Therefore, it is not intended to limit the scope of the present embodiments to a configuration in which part 36 is viewed by eye 25 and part 38 viewed by eye 30. In other words, for different wavelengths, part 36 is viewed by eye 30 and part 38 viewed by eye 25. For example, when the image is constituted by a light having three colors: red, green and blue, device 10 can be constructed such that eye 25 sees part 38 for the blue light and part 36 for the red light, while eye 30 sees part 36 for the blue light and part 38 for the red light. In such configuration, both eyes see an almost symmetric field-of-view for the green light. Thus, for every color, the two partial fields-of-view compliment each other.

The human visual system is known to possess a physiological mechanism capable of inferring a complete image based on several parts thereof, provided sufficient information reaches the retinas. This physiological mechanism operates on monochromatic as well as chromatic information received from the rod cells and cone cells of the retinas. Thus, in a cumulative nature, the two asymmetric field-of-views, reaching each individual eye, form a combined field-of-view perceived by the user, which combined field-of-view is wider than each individual asymmetric field-of-view.

According to a preferred embodiment of the present invention, there is a predetermined overlap between first 26 and second 32 partial fields-of-view, which overlap allows the user's visual system to combine parts 36 and 38 of image 34, thereby to perceive the image, as if it has been fully observed by each individual eye.

For example, the optical elements can be constructed such that the exclusive representations of partial fields-of-view 26 and 32 are, respectively, [−α, β] and [−β, α], resulting in a symmetric combined field-of-view 27 of [−β, β]. It will be appreciated that when β>>α>0, the combined field-of-view is considerably wider than each of the asymmetric field-of-views. Device 10 is capable of transmitting a field-of-view of at least 20 degrees, more preferably at least 30 degrees most preferably at least 40 degrees, in inclusive representation.

When the image is a multicolor image having a spectrum of wavelengths, different sub-spectra correspond to different, wavelength-dependent, asymmetric partial field-of-views, which, in different combinations, form different wavelength-dependent combined fields-of-view. For example, a red light can correspond to a first red asymmetric partial field-of-view, and a second red asymmetric partial field-of-view, which combine to a red combined field-of-view. Similarly, a blue light can correspond to a first blue asymmetric partial field-of-view, and a second blue asymmetric partial field-of-view, which combine to a blue combined field-of-view, and so on. Each such wavelength dependent asymmetric fields-of-view typically corresponds to a different part of the image. Thus, a multicolor configuration is characterized by a plurality of wavelength-dependent combined field-of-views. According to a preferred embodiment of the present invention the optical elements are designed and constructed so as to maximize the overlap between two or more of the wavelength-dependent combined field-of-views.

In terms of spectral coverage, the design of device 10 is preferably as follows: element 15 provides eye 25 with, say, a first sub-spectrum which originates from part 36 of image 34, and a second sub-spectrum which originates from part 38 of image 34. Element 19 preferably provides the complementary information, so as to allow the aforementioned physiological mechanism to infer the complete spectrum of the image. Thus, element 19 preferably provides eye 30 with the first sub-spectrum originating from part 38, and the second sub-spectrum originating from part 36.

When the multicolor image is formed from a discrete number of colors (e.g., an RGB display), the sub-spectra can be discrete values of wavelength. For example, a multicolor image can be provided by an OLED array having red, green and blue organic diodes (or white diodes used with red, green and blue filters) which are viewed by the eye as continues spectrum of colors due to many different combinations of relative proportions of intensities between the wavelengths of light emitted thereby. For such images, the first and the second sub-spectra can correspond to the wavelengths emitted by two of the blue, green and red diodes of the OLED array, for example the blue and red. Device 10 can be constructed such that, say, eye 30 is provided with blue light from part 36 and red light from part 38 whereas eye 25 is provided with red light from part 36 and blue light from part 38, such that the entire spectral range of the image is transmitted into the two eyes and the physiological mechanism reconstructs the image.

The light arriving at the input optical element of device 10 is preferably collimated, by a projection element or collimator 44 as described above. Collimator 44 can be, for example, a converging lens (spherical or non spherical), an arrangement of lenses and the like. Collimator 44 can also be a diffractive optical element, which may be spaced apart, carried by or formed in substrate 14. A diffractive collimator may be positioned either on the entry surface of substrate 14, as a transmissive diffractive element or on the opposite surface as a reflective diffractive element.

Following is a description of the principles and operations of optical device 10, in the preferred embodiments in which device 10 comprises one input optical element and two output optical elements.

Reference is now made to FIGS. 8a-b which are schematic illustrations of wavefront propagation within substrate 14, according to preferred embodiments in which diffractive elements are employed. Shown in FIGS. 8a-b are four principal light rays, 51, 52, 53 and 54, respectively emitted from four points, A, B, C and D, of image 34. The illustrations in FIGS. 8a-b lie in the y-z plane. The projections of the incident angles of rays 51, 52, 53 and 54 onto the y-z plane relative to the normal axis are denoted α_{I}⁻⁻, α_{I}⁻⁺, α_{I}⁺⁻ and α_{I}⁺⁺, respectively. As will be appreciated by one of ordinary skill in the art, the first superscript index refer to the position of the respective ray relative to the center of the field-of-view, and the second superscript index refer to the position of the respective ray relative to the normal from which the angle is measured, according to the aforementioned sign convention.

It is to be understood that this sign convention cannot be considered as limiting, and that one ordinarily skilled in the art can easily practice the present invention employing an alternative convention.

Similar notations will be used below for diffraction angles of the rays, with the subscript D replacing the subscript I. Denoting the superscript indices by a pair i, j, an incident angle is denoted generally as α_{I}^{ij}, and a diffraction angle is denoted generally as α_{D}^{ij}, where i j=“−−”, “−+”, “+−” or “−−”. The relation between each incident angle, α_{I}^{ij}, and its respective diffraction angle, α_{D}^{ij}, is given by Equation 4, above, with the replacements φ_{iy}→α_{I}^{ij}, and φ_{dy}→α_{D}^{ij}.

Points A and D represent the left end and the right end of image 34, and points B and C are located between points A and D. Thus, rays 51 and 53 are the leftmost and the rightmost light rays of a first asymmetric field-of-view, corresponding to a part A-C of image 34, and rays 52 and 54 are the leftmost and the rightmost light rays of a second asymmetric field-of-view corresponding to a part B-D of image 34. In angular notation, the first and second asymmetric field-of-views are, respectively, [α_{I}⁻⁻, α_{I}⁺⁻] and [α_{I}⁻⁺, α_{I}⁺⁺] (exclusive representations). Note that an overlap field-of-view between the two asymmetric field-of-views is defined between rays 52 and 53, which overlap equals [α_{I}⁻⁺, α_{I}⁺⁻] and corresponds to an overlap B-C between parts A-C and B-D of image 34.

In the configuration shown in FIGS. 8a-b, lens 45 magnifies image 34 and collimates the wavefronts emanating therefrom. For example, light rays 51-54 pass through a center of lens 45, impinge on substrate 14 at angles α_{I}^{ij} and diffracted by input optical element 13 into substrate 14 at angles α_{D}^{ij}. For the purpose of a better understanding of the illustrations in FIGS. 8a-b, only two of the four diffraction angles (to each side) are shown in each figure, where FIG. 8a shows the diffraction angles to the right of rays 51 and 53 (angles α_{D}⁺⁻ and α_{D}⁻⁻) and FIG. 8b shows the diffraction angles to the right of rays 52 and 54 (angles α_{D}⁻⁺ and α_{D}⁺⁺).

Each diffracted light ray experiences a total internal reflection upon impinging on the inner surfaces of substrate 14 if |α_{D}^{ij}|<α_{c} the absolute value of the diffraction angle, is larger than the critical angle α_{c}. Light rays with |α_{D}^{ij}|<α_{c} do not experience a total internal reflection hence escape from substrate 14. Generally, because input optical element 13 diffracts the light both to the left and to the right, a light ray may, in principle, split into two secondary rays each propagating in an opposite direction within substrate 14, provided the diffraction angle of each of the two secondary rays is larger than α_{c}. To ease the understanding of the illustrations in FIGS. 8a-b, secondary rays diffracting leftward and rightward are designated by a single and double prime, respectively.

Reference is now made to FIG. 8a showing a particular and preferred embodiment in which |α_{D}⁻⁺|=|α_{D}⁺⁻|=α_{c}. Shown in FIG. 8a are rightward propagating rays 51″ and 53″, and leftward propagating rays 52′ and 54′. Hence, in this embodiment, element 13 split all light rays between ray 51 and ray 52 into two secondary rays, a left secondary ray, impinging on the inner surface of substrate 14 at an angle which is smaller than α_{c}, and a right secondary ray, impinging on the inner surface of substrate 14 at an angle which is larger than α_{c}. Thus, light rays between ray 51 and ray 52 can only propagate rightward within substrate 14. Similarly, light rays between ray 53 and ray 54 can only propagate leftward. On the other hand, light rays between rays 52 and 53, corresponding to the overlap between the asymmetric field-of-views, propagate in both directions, because element 13 split each such ray into two secondary rays, both impinging the inner surface of substrate 14 at an angle larger than the critical angle, α_{c}.

Thus, light rays of the asymmetrical field-of-view defined between rays 51 and 53 propagate within substrate 14 to thereby reach second output optical element 19 (not shown in FIG. 8a), and light rays of the asymmetrical field-of-view defined between rays 52 and 54 propagate within substrate 14 to thereby reach first output optical element 15 (not shown in FIG. 8a).

In another embodiment, illustrated in FIG. 8b, the light rays at the largest entry angle split into two secondary rays, both with a diffraction angle which is larger than α_{c}, hence do not escape from substrate 14. However, whereas one secondary ray experience a few reflections within substrate 14, and thus successfully reaches its respective output optical element (not shown), the diffraction angle of the other secondary ray is too large for the secondary ray to impinge the other side of substrate 14, so as to properly propagate therein and reach its respective output optical element.

Specifically shown in FIG. 8b are original rays 51, 52, 53 and 54 and secondary rays 51′, 52″, 53′ and 54″. Ray 54 splits into two secondary rays, ray 54′ (not shown) and ray 54″ diffracting leftward and rightward, respectively. However, whereas rightward propagating ray 54″ diffracted at an angle α_{D}⁺⁺ experiences a few reflection within substrate 14 (see FIG. 8b), leftward propagating ray 54′ either diffracts at an angle which is too large to successfully reach element 15, or evanesces.

Similarly, ray 52 splits into two secondary rays, 52′ (not shown) and 52″ diffracting leftward and rightward, respectively. For example, rightward propagating ray 52″ diffracts at an angle α_{D}⁻⁺>α_{c}. Both secondary rays diffract at an angle which is larger than α_{c}, experience one or a few reflections within substrate 14 and reach output optical element 15 and 19 respectively (not shown). In the case that α_{D}⁻⁺ is the largest angle for which the diffracted light ray will successfully reach the optical output element 19, all light rays emitted from part A-B of the image do not reach element 19 and all light rays emitted from part B-D successfully reach element 19. Similarly, if angle α_{D}⁺⁻ is the largest angle (in absolute value) for which the diffracted light ray will successfully reach optical output element 15, then all light rays emitted from part C-D of the image do not reach element 15 and all light rays emitted from part A-C successfully reach element 15.

Thus, light rays of the asymmetrical field-of-view defined between rays 51 and 53 propagate within substrate 14 to thereby reach output optical element 15, and light rays of the asymmetrical field-of-view defined between rays 52 and 54 propagate within substrate 14 to thereby reach output optical element 19.

Any of the above embodiments can be successfully implemented by a judicious design of the input/output optical elements and the substrate.

For example, as stated, the input and output optical elements can be linear diffraction gratings having identical periods and being in a parallel orientation. This embodiment is advantageous because it is angle-preserving. Specifically, the identical periods and parallelism of the linear gratings ensure that the relative orientation between light rays exiting the substrate is similar to their relative orientation before the impingement on the input optical element. Consequently, light rays emanating from a particular point of the overlap part B-C of image 34, hence reaching both eyes, are parallel to each other. Thus, such light rays can be viewed by both eyes as arriving from the same angle in space. It will be appreciated that with such configuration viewing convergence is easily obtained without eye-strain or any other inconvenience to the viewer, unlike the prior art binocular devices in which relative positioning and/or relative alignment of the optical elements is necessary.

According to a preferred embodiment of the present invention the period, D, of the gratings and/or the refraction index, nₛ, of the substrate can be selected so to provide the two asymmetrical field-of-views, while ensuring a predetermined overlap therebetween. This can be achieved in more than one way.

Hence, in one embodiment, a ratio between the wavelength, λ, of the light and the period D is larger than or equal a unity:

λ/D≧1. (EQ. 14)

This embodiment can be used to provide an optical device operating according to the aforementioned principle in which there is no mixing between light rays of the non-overlapping parts of the field-of-view (see FIG. 8a).

In another embodiment, the ratio λ/D is smaller than the refraction index, nₛ, of the substrate. More specifically, D and nₛ can be selected to comply with the following inequality:

D>λ/(nₛp), (EQ. 15)

where p is a predetermined parameter which is smaller than 1.

The value of p is preferably selected so as to ensure operation of the device according to the principle in which some mixing is allowed between light rays of the non-overlapping parts of the field-of-view, as further detailed hereinabove (see FIG. 8b). This can be done for example, by setting p=sin(α_{D}^{MAX}), where (α_{D}^{MAX}) is a maximal diffraction angle. Because there are generally no theoretical limitations on α_{D}^{MAX} (apart from a requirement that its absolute value is smaller than 90°), it may be selected according to any practical considerations, such as cost, availability or geometrical limitations which may be imposed by a certain miniaturization necessity. Hence, in one embodiment, further referred to herein as the “at least one hop” embodiment, α_{D}^{MAX} is selected so as to allow at least one reflection within a predetermined distance x which may vary from about 30 mm to about 80 mm.

For example, for a glass substrate, with an index of refraction of nₛ=1.5 and a thickness of 2 mm, a single total internal reflection event of a light having a wavelength of 465 nm within a distance x of 34 mm, corresponds to α_{D}^{MAX}=83.3°.

In another embodiment, further referred to herein as the “flat” embodiment, α_{D}^{MAX} is selected so as to reduce the number of reflection events within the substrate, e.g., by imposing a requirement that all the diffraction angles will be sufficiently small, say, below 80°.

In an additional embodiment, particularly applicable to those situations in the industry in which the refraction index of the substrate is already known (for example when device 10 is intended to operate synchronically with a given device which includes a specific substrate), Equation 15 may be inverted to obtain the value of p hence also the value of α_{D}^{MAX}=sin⁻¹p.

As stated, device 10 can transmit light having a plurality of wavelengths. According to a preferred embodiment of the present invention, for a multicolor image the gratings period is preferably selected to comply with Equation 14, for the shortest wavelength, and with Equation 15, for the longest wavelength. Specifically:

λ_{R}/(nₛp)≦D≦λ_{B}, (EQ. 16)

where λ_{B} and λ_{R} are, respectively, the shortest and longest wavelengths of the multicolor spectrum. Note that it follows from Equation 14 that the index of refraction of the substrate should satisfy, under these conditions, nₛp≧λ_{R}/λ_{B}.

The grating period can also be smaller than the sum λ_{B}+λ_{R}, for example:

$$D = \frac{{λ}_{B} + {λ}_{R}}{{n}_{S} sin ( {α}_{D}^{MAX} ) + {n}_{A}} . \qquad ( EQ . 17 )$$

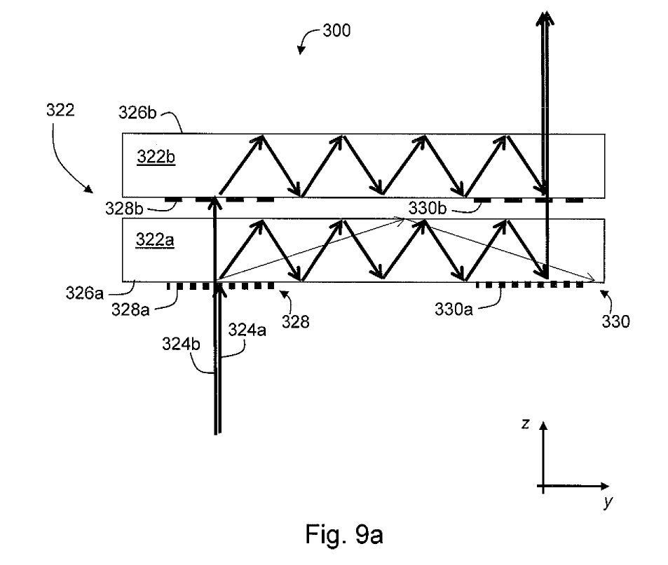

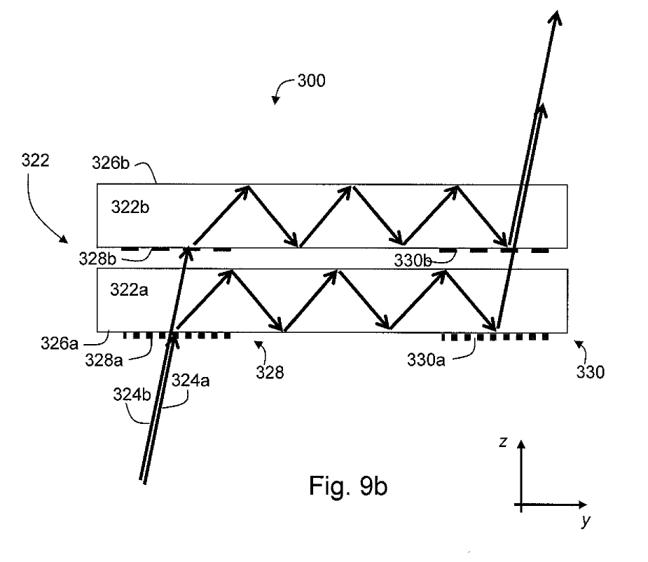

The above technique can be implemented using an optical apparatus 300 which is schematically illustrated in FIGS. 9a-b. Apparatus 300 preferably comprises a plurality of optical devices 322. The optical devices decompose the light into a plurality of portions where each portion corresponds to a different sub-spectrum. Each optical device transmits one portion of the light, preferably in different planes. Shown in FIGS. 9a-b are two such optical devices, designated 322a and 322b. Light, represented in FIGS. 9a-b by two light rays, 324a and 324b, is transmitted in a decomposed manner through apparatus 300: ray 324a is transmitted through device 322a and ray 324b is transmitted through device 322b.

The decomposing is preferably achieved on the entry of the light into each individual optical device. More specifically, the first optical device (e.g., device 322a) entraps a first portion of the light (e.g., ray 324a) therein and allows other portions (e.g., ray 324b) to continue to the next optical device (e.g., device 322b) and so on. According to a preferred embodiment of the present invention each optical device comprises a light-transmissive substrate 326 formed with one or more input optical elements 328. The input optical elements diffract the respective portion of the light into the light-transmissive substrate, in a substantially exclusive manner.

As used herein, “diffraction in a substantially exclusive manner” refers to a situation in which a portion X of the light is diffracted, and all other portions of the light are not diffracted or partially diffracted with suppressed diffraction efficiencies relative to the diffraction efficiency of portion X.

The exclusive diffraction can be better understood from the following numerical example, which is not intended to be limiting. Suppose that a particular optical device is designated for transmitting blue or near blue light, say, light at wavelength of 400-500 nm. For a wavelength λ of un-polarized light within this range (400 ≦λ≦500), the input optical element(s) of the optical device diffract the light into the light-transmissive substrate, at a diffraction efficiency of 15%-30%. On the other hand, for λ∉[400, 500] (e.g., the red and near-red portions of the light) the input optical element(s) either do not diffract the light at all or partially diffract it at a very low diffraction efficiency, e.g., below 10%, more preferably below 7%, even more preferably below 5%.

An illustration of the above example is shown in FIG. 9a. Both light rays 324a and 324b impinge on input optical element 328a of device 322a. Element 328a efficiently diffracts ray 324a which thus propagates within substrate 326a via total internal reflection. The propagation of ray 324a is illustrated as a solid line representing reflection of ray 324a off the surfaces of substrate 326a. Part of the energy of ray 324a is not diffracted by element 328a, but rather continues into element 328b at substrate 326b. However, this part of ray 324a typically does not propagate in substrate 326b via total internal reflection either because it is not diffracted by element 328b (or diffracted with low efficiency) or because it is diffracted by element 328b at an angle which is smaller than the critical angle.

Ray 324b also enters substrate 326a, but experiences only partial diffraction with low efficiency. The partial diffraction of ray 324b is shown as a dotted thin line representing wide-angle reflection off the surfaces of substrate 326a. Most of the optical energy carried by ray 324b is not trapped within substrate 326a, but continues in the direction of substrate 326b of device 322b and impinge on input optical element 328b, which, in the illustrative example of FIG. 9a is formed on the entry side of substrate 326b. Upon impinging on element 328b, ray 324b efficiently diffracts into substrate 326b and propagates therein via total internal diffraction. This propagation is illustrated as a broken red line representing reflection of ray 324b off the surfaces of substrate 326b. The input elements are preferably designed such that the diffraction angle of ray 324b within substrate 326b is significantly smaller than the diffraction angle of ray 324b within substrate 326a. According to a preferred embodiment of the present invention the input elements are designed such that the diffraction angle of ray 324b within substrate 326b is about the same as the diffraction angle of ray 324a within substrate 326a.

In various exemplary embodiments of the invention the input optical elements are located such that a sufficient spatial overlap is formed therebetween. In other words, when viewed from a direction perpendicular to the light-transmissive substrates, the input optical elements at least partially superimpose. The overlap between the input optical elements is preferably of at least 50%, more preferably at least 75%, even more preferably at least 95% (e.g., 100%). The overlap between the input optical elements allows rays which are not efficiently diffracted by one optical element to continue to the next optical element, with minimal or no diffraction. In the exemplified embodiment of FIG. 9a, the overlap between element 328a and 328b allows ray 324b which is not efficiently diffracted by element 328a to impinge on element 328b.

Upon impinging on element 328b, ray 324b is diffracted into substrate 326b and propagates therein via total internal diffraction. This propagation is illustrated as a solid line representing reflection of ray 324b off the surfaces of substrate 326b.

The incoming light rays in FIG. 9a are drawn perpendicular to the surfaces of the optical devices (zero incident angle, according to the aforementioned convention). When elements 328a and 328b are linear diffraction gratings, the relation between diffraction angles of the two rays can be calculated from the following equation:

(n_{S,326b} sin α_{D,324b})/(n_{S,326a} sin α_{D,324a})=(λ_{324b}/d_{328b})/(λ₃₂₄ₐ/d₃₂₈ₐ), (EQ. 18)

where n_{S,326a}, α_{D,324a}, λ₃₂₄ₐ, d₃₂₈ₐ, n_{S,326b}, α_{D,324b}, λ_{324b} and d_{328b} are the indices of refraction of substrates 326a and 326b, the diffraction angles and wavelengths of rays 324a and 324b, and the grating periods of input gratings 328a and 328b respectively. The grating period of element 328a and the refraction index n_{S,326a} can also be selected such that ray 324b is not diffracted at all.

Inclined light rays are diffracted at different angles and may not diffract at all. Such situation is shown in FIG. 9b. Rays 324a and 324b are now inclined (nonzero incident angle) to the surface of substrate 326a, and ray 324a is exclusively diffracted by element 328a. The entire optical energy of ray 324b enters substrate 326b, is diffracted by element 328b (which is specifically designed for the spectral range of ray 324b) and propagates within substrate 326b.

As will be appreciated by one ordinarily skilled in the art, when the incident angle is not within the field-of-view of the optical devices, both rays are not entrapped in the light transmissive substrates.

According to a preferred embodiment of the present invention each and all optical devices is characterized by the same field-of-view of apparatus 300. The advantage of this embodiment is that all colors are transmitted across the entire field-of-view.

Generally, a common field-of-view for all the optical devices can be achieved by selecting a set of calibrating parameters and constructing the optical devices such that for a particular choice of the calibrating parameters, all optical devices respectively diffract the portions of light through substantially identical diffraction angles. The calibrating parameters are preferably an incident angle for which the optical devices are calibrated, representative wavelengths for each of the sub-spectra, refraction indices of the light transmissive substrate and the like. For the configuration shown in FIGS. 9a-b the representative wavelengths of the sub-spectra are a first representative wavelength for device 322a and a second representative wavelength for device 322b. For example, when device 322a is designated for transmitting blue and near-blue and device 322b designated for transmitting red and near-red wavelengths, λ₁ can be a typical wavelength of a blue light (say, 470 nm) and λ₂ can be a typical wavelength of a red light (say, 620 nm).

A common field-of-view for both devices can then be achieved by demanding that the diffraction angle of a light ray of wavelength λ₁ impinging at a predetermined incident angle α_{I} on device 322a, equals the diffraction angle of a light ray of wavelength λ₂ impinging the same incident angle α_{I} on device 322b. Conveniently, but not obligatorily, the refraction indices of substrate 326a and 326b can be the same, and the calibrating incident angle α_{I} can be set to zero, as shown in FIG. 9a. With such choice of the calibrating parameters, the aforementioned equal diffraction angles can be achieved by constructing element 328a as a linear diffraction grating with period d₁, and element 328b as a linear diffraction grating with period d₂, where d₁ and d₂ satisfy d₁/d₂=λ₁/λ₂. This continent choice can be generalized to more than two optical devices. For example, when three optical devices are employed, the grating periods of the input elements can be set to satisfy d₁:d₂:d₃=λ₁:λ₂:λ₃.

Each light-transmissive substrate is further formed with one or more output optical elements 330. Shown in FIGS. 9a-b are two output optical elements (one for each substrate): element 330a formed in substrate 326a and element 330b formed in substrate 326b. Elements 330 serve for recomposing the individual portions of the light by coupling the light rays out of apparatus 300. Similarly to the input optical elements, each output optical element diffracts the respective portion of the light out of the respective light-transmissive substrate, and allows the other portions of the light to pass with minimal or no diffraction. For example, 324a is diffracted by element 330a out of substrate 326a, and passes, with minimal or no diffraction through element 330b. Element 330b exclusively diffracts ray 324b out of substrate 326b, and the two rays exit apparatus 300 in parallel directions. In one embodiment, the two light rays are recomposed to the original light ray.

FIGS. 9a-b show an exemplified situation in which ray 324a is not diffracted by element 330b. Whether or not any particular light ray successfully impinges on one of the output optical elements to be diffracted out of the optical device, depends on the wavelength of the light, the initial angle of incidence upon the input optical element, the size of the input and output optical elements and the distance therebetween, and the characteristics of the optical device. In any event, each optical device is designed to diffract light of a predetermined wavelength and a predetermined angle of incidence at a prescribed diffraction angle and at an optimal efficiency. As a numerical example, when device 322b is designed to provide a horizontal field-of-view of [−12°, +12°] by diffracting red light having wavelength of 620 nm with maximal efficiency using grating period of 513 nm, blue light having wavelength of 470 nm is not diffracted by same device into total internal diffraction at angles of incidence below 4.8°, and is diffracted with relatively low efficiency for incidence angles between 4.8° and 12°.

In various exemplary embodiments of the invention each optical relay device comprises two output optical elements. For example, the configuration shown in FIGS. 7a-b can be employed for one or more of the relay devices of apparatus 300.

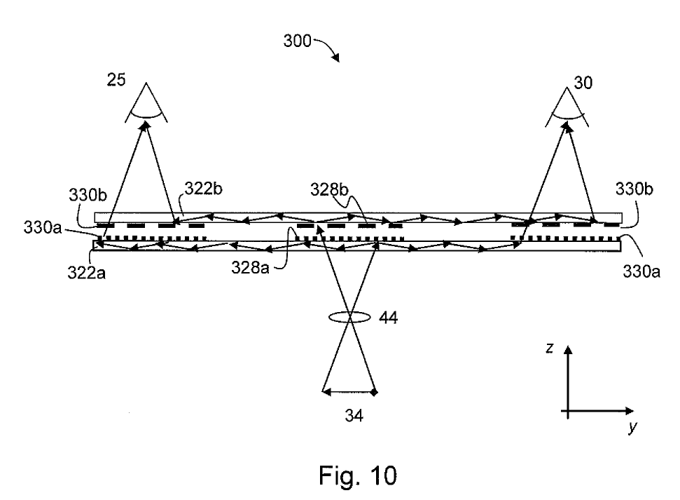

Reference is now made to FIG. 10 which is a schematic illustration of apparatus 300 in an embodiment in which each optical relay device comprises two output elements. Each of optical devices 322 comprises two output optical elements, which diffract the light into the eyes 30 and a second eye 25. In this embodiment, each input optical element diffracts the light rays (of the respective sub-spectrum) such that the each light ray is bifurcated, propagates within the respective substrate in two directions, and exits the substrate in a form of two substantially parallel light rays, as further detailed hereinabove.

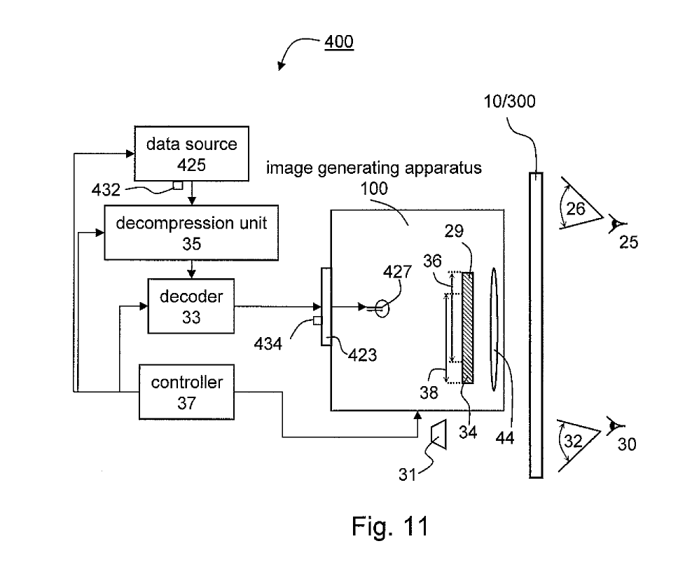

Reference is now made to FIG. 11 which is a schematic illustration of an optical system 400, according to various exemplary embodiments of the present invention. System 400 can comprise an optical relay device, such as device 10, or an optical apparatus having two or more relay devices, e.g., apparatus 300. Device 10 or apparatus 300 serves for transmitting image 34 into first eye 25 and second eye 30 of the user. System 400 can further comprise an image generating apparatus 100 and collimator 44. Apparatus 100 provides optical relay device 10 with a light beam modulated to constitute the image.

Image generating apparatus 100 can be either analog or digital. An analog image generating apparatus typically comprises a light source 427 and at least one image carrier 29. Representative examples for light source 427 include, without limitation, a lamp (incandescent or fluorescent), one or more LEDs or OLEDs, and the like. Representative examples for image carrier 29 include, without limitation, a miniature slide, a reflective or transparent microfilm and a hologram. Apparatus 100 can comprise a passive display panel which modulates light emitted from source 427.

The light source can be positioned either in front of the image carrier (to allow reflection of light therefrom) or behind the image carrier (to allow transmission of light therethrough). Optionally and preferably, apparatus 100 comprises a miniature CRT. Miniature CRTs are known in the art and are commercially available, for example, from Kaiser Electronics, a Rockwell Collins business, of San Jose, Calif.

Light sources suitable for a digital image generating system include, without limitation, a lamp (incandescent or fluorescent), one or more LEDs (e.g., red, green and blue LEDs) or OLEDs, and the like. Suitable passive display panels include, without limitation, rear-illuminated transmissive or front-illuminated reflective LCD, Digital Light Processing™ (DLP™) units, and the like. Transparent miniature LCDs are commercially available, for example, from Kopin Corporation, Taunton, Mass. Reflective LCDs are are commercially available, for example, from Brillian Corporation, Tempe, Ariz. Miniature OLED arrays are commercially available, for example, from eMagin Corporation, Hopewell Junction, N.Y. DLP™ units are commercially available, for example, from Texas Instruments DLP™ Products, Plano, Tex. The pixel resolution of the digital miniature displays varies from QVGA (320×240 pixels) or smaller, to WQUXGA (3840×2400 pixels).

System 400 is particularly useful for enlarging a field-of-view of devices having relatively small screens. For example, cellular phones and personal digital assistants (PDAs) are known to have rather small on-board displays. PDAs are also known as Pocket PC, such as the trade name iPAQ™ manufactured by Hewlett-Packard Company, Palo Alto, Calif. The above devices, although capable of storing and downloading a substantial amount of information in a form of single frames or moving images, fail to provide the user with sufficient field-of-view due to their small size displays.

Thus, according to a preferred embodiment of the present invention system 400 comprises a data source 425 which can communicate with apparatus 100 via a data source interface 423. Any type of communication can be established between interface 423 and data source 425, including, without limitation, wired communication, wireless communication, optical communication or any combination thereof. Optionally and preferably data source 425 and source interface 423 are operatively associated with wireless transceivers 432 and 434, respectively, to establish wireless communication thereamongst. Interface 423 is preferably configured to receive a stream of imagery data (e.g., video, graphics, etc.) from data source 425 and to input the data into apparatus 100. Many types or data sources are contemplated. According to a preferred embodiment of the present invention data source 425 is a communication device, such as, but not limited to, a cellular telephone, a personal digital assistant device (PDA) and a portable computer (laptop). Additional examples for data source 425 include, without limitation, television apparatus, portable television device, satellite receiver, video cassette recorder, digital versatile disc (DVD) player, digital moving picture player (e.g., MP4 player), digital camera, video graphic array (VGA) card, and many medical imaging apparatus, e.g., ultrasound imaging apparatus, digital X-ray apparatus (e.g., for computed tomography) and magnetic resonance imaging apparatus.

In addition to the imagery information, data source 425 may generates also audio information. The audio information can be received by interface 423 and provided to the user, using an audio unit 31 (speaker, one or more earphones, etc.).

According to various exemplary embodiments of the present invention, data source 425 provides the stream of data in an encoded and/or compressed form. In these embodiments, system 400 further comprises a decoder 33 and/or a decompression unit 35 for decoding and/or decompressing the stream of data to a format which can be recognized by apparatus 100. Decoder 33 and decompression unit 35 can be supplied as two separate units or an integrated unit as desired.

System 400 preferably comprises a controller 37 for controlling the functionality of apparatus 100 and, optionally and preferably, the information transfer between data source 425 and apparatus 100. Controller 37 can control any of the display characteristics of apparatus 100, such as, but not limited to, brightness, hue, contrast, pixel resolution and the like. Additionally, controller 37 can transmit signals to data source 425 for controlling its operation. More specifically, controller 37 can activate, deactivate and select the operation mode of data source 425. For example, when data source 425 is a television apparatus or being in communication with a broadcasting station, controller 37 can select the displayed channel; when data source 425 is a DVD or MP4 player, controller 37 can select the track from which the stream of data is read; when audio information is transmitted, controller 37 can control the volume of audio unit 31 and/or data source 425.

System 400 or a portion thereof (e.g., device 10) can be integrated with a wearable device, such as, but not limited to, a helmet or spectacles, to allow the user to view the image, preferably without having to hold optical relay device 10 by hand.

Alternatively system 400 or a portion thereof can be adapted to be mounted on an existing wearable device. For example, in one embodiment device 10 is manufactured as a spectacles clip which can be mounted on the user's spectacles, in another embodiment, device 10 is manufactured as a helmet accessory which can be mounted on a helmet's screen.

The present embodiments can also be provided as add-ons to the data source or any other device capable of transmitting imagery data. Additionally, the present embodiments can also be used as a kit which includes the data source, the image generating system, the binocular device and optionally the wearable device. For example, when the data source is a communication device, the present embodiments can be used as a communication kit.

Following are general technical details of a light transmissive substrate and diffractive optical elements which can be employed by the device apparatus and system of some embodiments of the present invention.

The thickness, t, of the light transmissive substrate is preferably from about 0.1 mm to about 5 mm, more preferably from about 1 mm to about 3 mm, even more preferably from about 1 to about 2.5 mm. For multicolor use, t is preferably selected to allow simultaneous propagation of plurality of wavelengths, e.g., t>10λ_{R}. The width/length of the substrate is preferably from about 10 mm to about 100 mm.

A typical width/length of the diffractive optical elements depends on the application for which the device, apparatus and/or system is used. For example, in a near eye display applications, such as the display described in U.S. Pat. No. 5,966,223, the typical width/length of the diffractive optical elements is from about 5 mm to about 20 mm. The contents of U.S. Patent Application No. 60/716,533, which provides details as to the design of the diffractive optical elements and the selection of their dimensions, are hereby incorporated by reference.

For different viewing applications, such as the application described in U.S. Pat. No. 6,833,955, the contents of which are hereby incorporated by reference, the length of the substrate can be 1000 mm or more, and the length of the output diffractive optical element can have a similar size. When the length of the substrate is longer than 100 mm, t is preferably larger than 5 millimeters. This embodiment is advantageous because it reduces the number of hops and maintains the substrate within reasonable structural/mechanical conditions.

In various exemplary embodiments of the invention the light transmissive material is characterized by a birefringence, Δn, which is substantially low in its absolute value. The birefringence of the light transmissive material of the present embodiments preferably satisfies the inequality |Δn|<∈, where ∈ is lower than the birefringence of polycarbonate. In various exemplary embodiments of the invention ∈ equals 0.0005, more preferably 0.0004, more preferably 0.0003, even more preferably 0.0002.

In various exemplary embodiments of the invention the light transmissive material comprises a polymer or a copolymer. Polymers or copolymers suitable for the present embodiments are characterized by isotropic optical activity and at least one, more preferably at least two additional characteristics selected from: high transmission efficiency, good molding ability, low moisture permeability, chemical resistance and dimensional stability.

Exemplary light transmissive materials suitable for the present embodiments include, without limitation, cycloolefin polymers, cycloolefin copolymers and other polycyclic polymers from cycloolefinic monomers such as norbornene, hydrocarbyl and/or halogen substituted norbomene-type monomers, polymers and/or copolymers containing N-halogenated phenyl maleimides, N-halogenated phenyl bismaleimides, halogenated acrylates, halogenated styrenes, halogenated vinyl ethers, halogenated olefins, halogenated vinyl isocyanates, halogenated N-vinyl amides, halogenated allyls, halogenated propenyl ethers, halogenated methacrylates, halogenated maleates, halogenated itaconates, halogenated crotonates, and other amorphous transparent plastics.

In various exemplary embodiments of the invention the light transmissive material comprises a cycloolefin polymer or a cycloolefin copolymer, such as those commercially available from suppliers such as Zeon, Japan, under the trade-names Zeonex™ and Zeonor™, from Ticona, a business of Celanese Corporation, USA, under the trade-name Topas™, and from Mitsui Chemicals Group under the trade name APEL™. Although both cycloolefin polymer and cycloolefin copolymer are preferred over the above light transmissive materials, cycloolefin polymer is more favored over cycloolefin copolymer, because the temperature window for fabricating a substrate which comprises a cycloolefin polymer is wider.

In accordance with some embodiments of the present invention, a method suitable for designing an optical apparatus having one or more optical relay devices is provided. Each relay device comprises a light-transmissive substrate having at least one input diffraction grating and at least one output diffraction grating.

The method can begin by selecting grating parameters (grating profile, period, duty cycle, modulation depth) for the diffraction gratings. In various exemplary embodiments of the invention there is at least one nonuniform grating parameter for at least one of the diffraction gratings so as to ensure nonuniform diffraction efficiency on the output of the device. For example, one or more of the output diffraction grating can have a nonuniform duty cycle and/or a nonuniform modulation depth. The grating period can be calculated based on the desired or preselected field-of-view of the apparatus, e.g., by means of one or more of Equations 11 and 14-17. Preferably, one or more of the gratings has a plurality of segments each having a specific diffraction efficiency as described above. In this embodiment, the selection of grating parameters includes selection of at least one of grating profile, duty cycle and modulation depth of each segment. The length of each segment can be selected dynamically or inputted as desired.

Optionally and preferably the method includes a step in which the arrangement of the gratings and substrate are selected, e.g., based on the desired or preselected dimensions for the eye-box and eye-relief. The arrangement typically includes the sizes of the gratings and substrate, and the relative positions of the gratings on the substrate. For given dimensions for the eye-box and eye-relief, the sizes of the gratings can be calculated by means of Equations 8-10 and optionally 13.

The method can continue by employing a ray tracing algorithm which calculates optical paths from an image source through the light relay device(s) and into the eye-box (or eye-boxes if it is desired to design relay device(s) having more than one output grating). The algorithm calculates the optical paths under constraints induced by the arrangement of the gratings and substrate and by the grating parameters. The calculations of optical paths are typically in accordance with the equations governing diffraction (see, e.g., Equations 2-5).

Typically, a white ray tracing is employed. Thus, the algorithm receives a white light input, and preferably calculates a plurality of optical paths hence simulates ray tracing. In various exemplary embodiments of the invention the algorithm calculates the expected diffraction efficiency for optical path. The diffraction efficiency can be calculated using the Maxwell equations or an approximation thereof. For example, the efficiency can be calculated according to the teachings of Eriksson et al., supra, or Streifer et al., “Coupling coefficient for distributed feedback single- and double-heterostructure diode lasers,” IEEE J Quantum Electron, 11:867-873, 1975.

Once ray tracing is completed the method calculates the color profile across the eye-box. In various exemplary embodiments of the invention the method repeats the selection of grating parameters, ray-tracing simulation and color profile calculation until the color profile across the eye-box is sufficiently uniform. The repetition can be performed iteratively. Color uniformity can be characterized by calculating distances in the CIE (L*, a*, b*) color space as described above, whereby “shorter” distances correspond to higher uniformity. Preferably, the repetition is done until the maximal color deviation σ_{MAX} is less than 50 units, more preferably less than 40 units, more preferably less than 30 units, more preferably less than 20 units.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

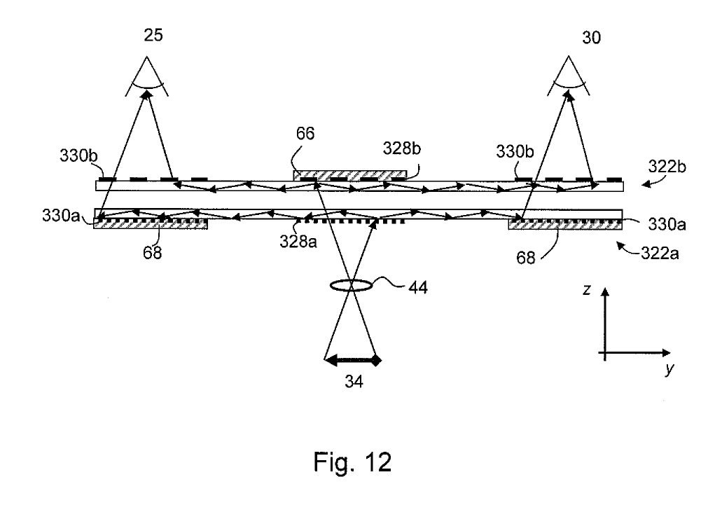

In accordance with some embodiments of the present invention, three types of optical apparatus, referred to as types I, II and III, were designed. Each apparatus was designed to include two optical relay devices, each having a light-transmissive substrate formed with one input diffraction grating and two output diffraction grating, as illustrated in FIG. 12.

In each apparatus, the first relay device 322a (lower device in FIG. 12) was designated to relay blue and near blue light, and the second relay device 322b (upper device in FIG. 12) was designated to relay red and near red light. All gratings had binary profiles, with ridges which are leveled with the surfaces of the substrates.

In all three types of apparatus, the thickness of each substrate was 2.3 mm and the index of refraction of each substrate was 1.51. The distance between the substrates along the z-direction was 0.1 mm. The distance between the center of the input grating 328 and each center of the two output gratings 330 was 30 mm, resulting in a nominal IPD of 60 mm. The lengths (along the y-direction) of the input 328 and output 330 gratings were 10 mm and 16 mm, respectively. The eye-relief was selected to be 25 mm, and the length of the eye-box of was 3 mm which is approximately the pupil's diameter.

The periods of the input and output gratings, were 380 nm for the blue and near blue relay device, and 510 nm for the red and near red relay device, respectively, for all three types of apparatus.

In the first relay device 322a of each apparatus, the grating period was 380 nm and the modulation depth of the input grating 328a was 216 nm. A single period of the input grating 328a included 68.4 nm ridge and 311.6 nm groove, corresponding to a duty cycle of 18%. As shown in FIG. 12, the input grating 328a of this device was designed to operate in transmission mode, and the output gratings 330a of this device were designed to operate in reflection mode. The design included a reflective coat 68 for each of the two output gratings.

In the second relay device 322b of each apparatus, the grating period was 510 nm and the modulation depth of the input grating 328b was 180 nm. A single period of the input grating 328b included 81.6 nm ridge and 428.4 nm groove, corresponding to a duty cycle of 16%. In this device, the input grating 328b was designed to operate in reflection mode, and the output gratings 330b were designed to operate in transmission mode. The design included a reflective coat 66 for the input grating.

The three types of apparatus differed in the diffraction efficiency functions of their output gratings.

In the apparatus of type I, each output grating had a uniform diffraction efficiency. The grating parameters were selected so as to maximize output for a wavelength of 555 nm at 0°. In the first relay device (designated for blue light) the modulation depth of the output gratings was 160 nm, and the duty cycle was 52%. In the second relay device (designated for red light) the modulation depth of the output gratings was 160 nm, and the duty cycle was 38%.

In the apparatus of type II, each output grating consisted of three 5.33 mm width segments, such that the diffraction efficiency of the kth segment (k=1, 2, 3) was 1/k times the maximal efficiency for wavelength of 555 nm at 0°. Thus the diffraction efficiencies of the three segments were 1, ½ and ⅓ respectively. In the first relay device of the type II apparatus the modulation depth of the output gratings was 160 nm, and the duty cycles for the three segments were 36%, 40% and 52%. In the second relay device of the type II apparatus the modulation depth of the output gratings was 160 nm, and the duty cycles for the three segments were 80%, 76% and 38%.

In the apparatus of type III, each output grating consisted of 8 segments and the duty cycle of each segment was independently varied until a substantially uniform color profile was obtained across the eye-box. The width of each segment was 2 mm. In this type of apparatus, the modulation depth of the output gratings was 280 nm for the first relay device and 96 nm form the second relay device. The following sets of duty cycles were obtained during simulations: for the first relay device, 15%, 15%, 13%, 15%, 15%, 16%, 23% and 14%, and for the second relay device, 19%, 19%, 22%, 14%, 13%, 12%, 12% and 23%, respectively for grating segments Nos. 1-8.

Ray tracing simulations were performed for each apparatus considering uniform white light impinging on the input grating of the first device.

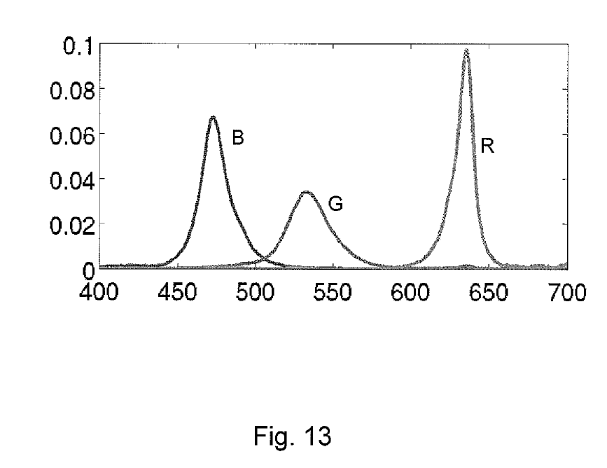

The spectra of RGB primaries of the input white light are shown in FIG. 13. The X, Y, Z tristimulus values used for the RGB values shown in FIG. 13 and the white point is provided in Table 1:

TABLE 1

| | R | G | B | W |
|---|---|---|---|---|
| X | 0.9349 | 0.3376 | 0.2469 | 1.5193 |
| Y | 0.4076 | 1.0351 | 0.2414 | 1.6841 |
| Z | 0.0111 | 0.0859 | 1.5544 | 1.6514 |

Light energy was integrated within the eye-box for angles of incidence onto the eye-box within a horizontal field of view of [−10°, +10°] in steps of 2°. For each such angle the CIE (L*, a*, b*) color coordinates were computed.

The L*, a*, b* coordinates of the R G B primaries, as computed using the white point of Table 1 above, are provided in Table 2:

TABLE 2

| | R | G | B | W |
|---|---|---|---|---|
| L* | 56 | 83 | 45 | 100 |
| a* | 114 | −112 | 11 | 0 |
| b* | 87 | 95 | −91 | 0 |

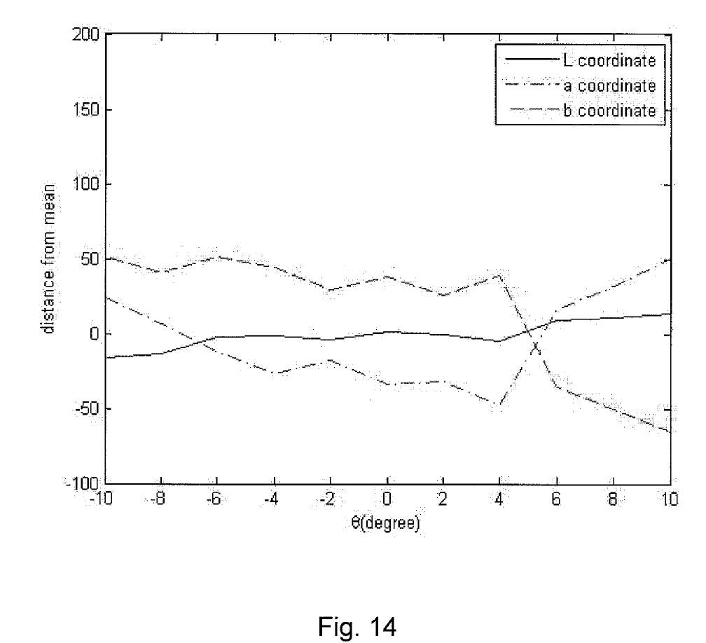

The results of the simulations for type I, type II and type III apparatus are shown in FIGS. 14, 15 and 16, respectively. Each figure is a graph depicting the individual deviation of each of the three CIE (L*, a*, b*) coordinates as a function of the angle of the outgoing light rays. The graphs depict the angular dependence over a field-of-view of [−10°, +10°].

Referring to FIG. 14 (results for type I), although the L* coordinate appears to be uniform, the a* coordinate (corresponding to the red-green axis in the CIE space) and the b* coordinate (corresponding to the blue-yellow axis in the CIE space) vary, resulting in a non uniform color across the field-of-view. Thus, the type I apparatus converts an all-white image into a virtual image in which one part of its cross section (from about −10° to about −6°) is red-yellow (orange), another part of its cross section (from about −6° to about 5°) is yellow-green, and an additional part of its cross section (from about 5° to about 10°) is blue-red. The maximal calculated color deviation for this apparatus was over 80 ΔE* units and across most of the image the color deviation was larger than 50 ΔE* units.

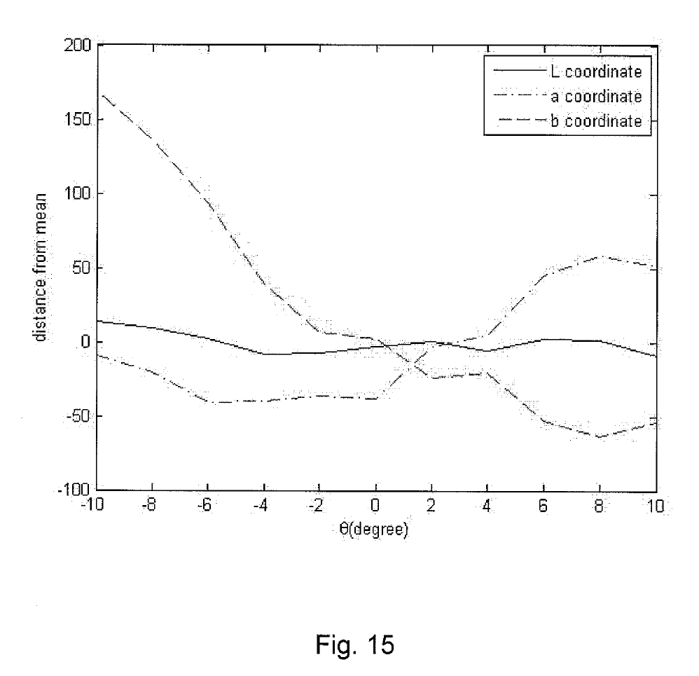

Referring to FIG. 15 (results for type II), the L* coordinate appears to be uniform but the a* and b* coordinates vary, though in a different manner compared to the results with the type I apparatus. The maximal calculated color deviation for this apparatus was over 150 ΔE* units, and while within the center range of the image, between −2° and +4°, the color deviation was less than 50 ΔE* units, the right and left parts of the image, over two thirds of the field of view, experienced color deviation larger than 50 ΔE* units.

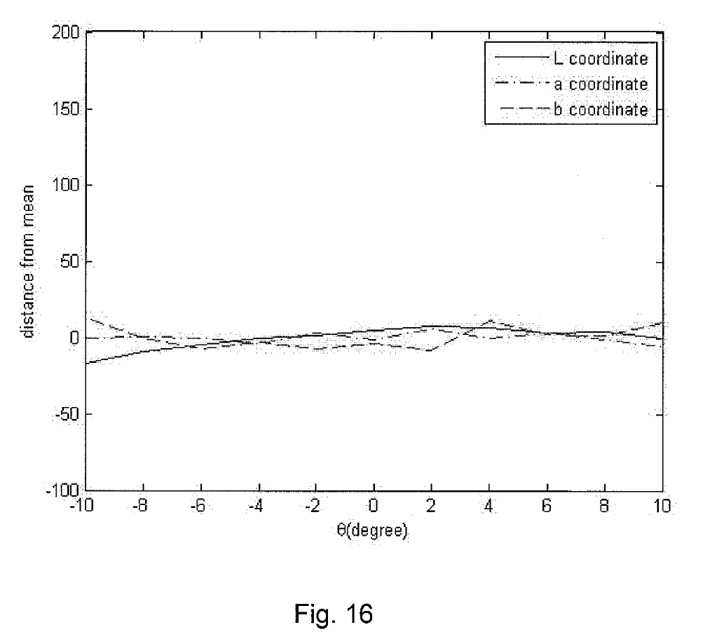

Referring to FIG. 16 (results for type III), all three CIE coordinates are substantially uniform across the entire field-of-view. The maximal calculated color deviation for this apparatus was less than 20 ΔE* units.

The present Examples demonstrate that the at least a few embodiments of the present invention provide outgoing light beam to a predetermined eye-box in a manner such that for each outgoing light ray arriving to the eye-box, the color difference between the color of the outgoing light ray and the color of a corresponding incoming light ray is substantially small.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An optical relay device, comprising a light-transmissive substrate having a plurality of diffractive optical elements, wherein at least one diffractive optical element is characterized by nonuniform diffraction efficiency;
said substrate and said diffractive optical elements being designed and constructed to relay at least a portion of a polychromatic light beam emanating from an object to at least one predetermined eye-box in a manner such that for each point of the object, there is a set of parallel outgoing light rays originating from said point and arriving to said eye-box, wherein a color difference between any two parallel light rays of said set is less than 50 ΔE* units.

2. An optical relay device, comprising a light-transmissive substrate having a plurality of diffractive optical elements, wherein at least one diffractive optical element is characterized by nonuniform diffraction efficiency;
said substrate and said diffractive optical elements being designed and constructed to relay at least a portion of an polychromatic incoming light beam to provide an outgoing light beam propagating in the air in a manner such that the color difference between colors of any two outgoing light rays respectively originating from two incoming light rays having the same color is less than 50 ΔE* units over at least part of said outgoing light beam.

3. An optical relay device, comprising a light-transmissive substrate having a plurality of diffractive optical elements, wherein at least one diffractive optical element is characterized by nonuniform diffraction efficiency;
said substrate and said diffractive optical elements being designed and constructed such that when an incoming white light beam impinges the device, an outgoing light beam characterized by a maximal color deviation of less than 50 ΔE* units across a field-of-view of at least 10 degrees exits the device into at least one predetermined eye-box.

4. Apparatus for transmitting a light beam having a spectrum of wavelengths, the apparatus comprising a plurality of optical relay devices wherein at least one optical relay device of said plurality of optical relay devices is the device of claim 1.

5. The apparatus of claim 4, wherein each optical relay device of said plurality of optical relay devices is designed and constructed to relay, substantially exclusively, a different spectral portion of the light beam, each spectral portion corresponding to a sub-spectrum of the spectrum.

6. The apparatus of claim 5, wherein said at least one diffractive optical element comprises at least one output diffractive optical element designed and constructed to diffract a respective spectral portion of the light beam out of said substrate, while allowing other spectral portions of the light beam to pass through said at least one output diffractive optical element with minimal or no diffraction.

7. The apparatus of claim 4, wherein each optical relay device is a planar optical device engaging a different plane.

8. A system for providing an image of an object to a user, comprising the optical relay device of claim 1, and an image generating system for providing said optical relay device with collimated light constituting said image.

9. A system for providing an image of an object to a user, comprising the apparatus of claim 4, and an image generating system for providing said optical relay device with collimated light constituting said image.

10. A method of transmitting a light beam, comprising operating an optical relay device which comprises a light-transmissive substrate having a plurality of diffractive optical elements wherein at least one diffractive optical element is characterized by nonuniform diffraction efficiency;
said substrate and said diffractive optical elements being designed and constructed to relay at least a portion of a polychromatic light beam emanating from an object to at least one predetermined eye-box in a manner such that for each point of the object, there is a set of parallel outgoing light rays originating from said point and arriving to said eye-box, wherein a color difference between any two parallel light rays of said set is less than 50 ΔE* units.

11. The device of claim 1, wherein said plurality of diffractive optical elements comprises at least one output diffractive optical element respectively corresponding to said at least one predetermined eye-box, and wherein a length of each predetermined eye-box is less than 80% of a length of a respective output diffractive optical element.

12. The device of claim 1, wherein said plurality of diffractive optical elements comprises at least one output diffractive optical element respectively corresponding to said at least one predetermined eye-box, and wherein a length of each predetermined eye-box is less than 50% of a length of a respective output diffractive optical element.

13. A method of transmitting an image of an object, comprising diffracting at least a portion of a polychromatic light beam emanating from the object to provide an outgoing light beam propagating in the air, such that for each point of the object, there is a set of parallel outgoing light rays originating from said point and arriving to at least one predetermined eye-box, wherein a color difference between any two parallel light rays of said set is less than 50 ΔE* units.

14. A method of transmitting light, comprising diffracting at least a portion of a polychromatic light beam to provide an outgoing light beam propagating in the air, such that the color difference between colors of any two outgoing light rays respectively originating from two incoming light rays having the same color is less than 50 ΔE* units over at least part of said outgoing light beam.

15. The device of claim 2, wherein said at least part of said outgoing light beam is characterized by a field-of-view of at least 10 degrees.

16. The device of claim 2, wherein said at least part of said outgoing light beam comprises a plurality of outgoing light rays propagating in the air into at least one predetermined eye-box.

17. The method of claim 13, wherein an area of said at least one predetermined eye-box is less than 80% from a cross-sectional area of said outgoing light beam.

18. The method of claim 13, wherein an area of said at least one predetermined eye-box is less than 50% from a cross-sectional area of said outgoing light beam.

19. The method of claim 13, wherein said diffracting is by an optical relay device having a light-transmissive substrate having a plurality of diffractive optical elements, and wherein at least one diffractive optical element is characterized by nonuniform diffraction efficiency.

20. The device of claim 1, wherein said color difference or said color deviation is less than 40 ΔE* units.

21. The device of claim 1, wherein said color difference or said color deviation is less than 30 ΔE* units.

22. The device of claim 1, wherein said color difference or said color deviation is less than 20 ΔE* units.

23. The device of claim 1, wherein said plurality of diffractive optical elements comprises an input diffractive optical element, a left output diffractive optical element and a right output diffractive optical element being laterally displaced from said left output diffractive optical element.

24. The device of claim 1, wherein at least one output diffractive optical element is a linear grating.

25. The device of claim 24, wherein said nonuniform diffraction efficiency is effected by a nonuniform duty cycle of said linear grating.

26. The device of claim 24, wherein said nonuniform diffraction efficiency is effected by a nonuniform modulation depth.

27. The device of claim 1, wherein at least one of said plurality of diffractive optical elements is a reflective optical element.

28. The device of claim 27, wherein said reflective optical element comprises a reflective coat.

29. The device of claim 1, wherein said at least one diffractive optical element comprises a plurality of segments, and wherein at least two of said plurality of segments are characterized by different diffraction efficiencies.

30. The device of claim 29, wherein said at least one diffractive optical element comprises at least one diffraction grating.

31. The device of claim 1, wherein at least one of said plurality of diffractive optical elements comprises a linear diffraction grating having a substantially uniform modulation depth of about 216 nm and a nonuniform duty cycle being effected by eight concatenated segments of said grating, wherein respective duty cycles characterizing said eight concatenated segments are: about 15%, about 15%, about 13%, about 15%, about 15%, about 16%, about 23% and about 14%.

32. The device of claim 1, wherein at least one of said diffractive optical elements comprises a linear diffraction grating having a substantially uniform modulation depth of about 180 nm and a nonuniform duty cycle being effected by eight concatenated segments of said grating, wherein respective duty cycles characterizing said eight concatenated segments are: about 19%, about 19%, about 22%, about 14%, about 13%, about 12%, about 12% and about 23%.

33. The apparatus of claim 4, wherein said plurality of optical relay devices comprises a first optical relay device and a second optical relay device.

34. A method of designing an optical apparatus having at least one light-transmissive substrate and a plurality of diffraction gratings in a predetermined arrangement over the at least one light-transmissive substrate, the method comprising:
selecting grating parameters for said diffraction gratings;
under constraints induced by the arrangement and said grating parameters, simulating white ray tracing, within the apparatus and into at least one predetermined eye-box being at a predetermined distance from said at least one substrate, for a plurality of different rays and a plurality of different wavelengths;
based on said ray tracing, calculating a color profile across said at least one predetermined eye-box; and
repeating said selection, said simulation and said calculation until said color profile is characterized by a maximal color deviation of less than 50 ΔE* units.

35. The method of claim 34, wherein said selecting said grating parameters comprises defining a plurality of segments for at least one grating of said plurality of gratings, and selecting a diffraction efficiency for each segment of said plurality of segments.

36. The method of claim 35, wherein said at least one grating has a uniform period, and wherein said selecting said diffraction efficiency comprises selecting a duty cycle.

37. The method of claim 35, wherein said at least one grating has a uniform period, and wherein said selecting said diffraction efficiency comprises selecting a modulation depth.

38. The device of claim 29, wherein said plurality of segments comprises at least eight segments.

39. The device of claim 30, wherein said at least one grating has a uniform period, and wherein a length of at least one segment of said plurality of segments is shorter than a minimal hop-length characterizing ray propagation within said at least one light transmissive substrate.

40. The device of claim 30, wherein said at least one grating has a uniform period, and wherein a length of at least one segment of said plurality of segments is shorter than 3 millimeters.

41. The device of claim 30, wherein said at least one grating has a uniform period, and wherein a length of at least one segment of said plurality of segments equals said period.
